(19) United States
(12) Patent Application Publication
(10) Pub. No.: US 2026/0206695 A1
(43) Pub. Date: Jul. 23, 2026

(54) BIOMIMETIC VASCULAR SYSTEM INTERFACING DEVICE FOR CONTROLLED PRECISION EXCHANGE OF FLUIDS WITH TREE SAP WOOD

(71) Applicant: E-ROOTREE LLC, Leander, TX (US)

(72) Inventor: SRILAKSHMI BHAVANI NANDAMURI, Leander, TX (US)

(21) Appl. No.: 19/567,310

(22) Filed: Mar. 16, 2026

(51) Int. Cl. A01G 23/00

(52) U.S. Cl. CPC A01G 23/00

(57) ABSTRACT

A tree interfacing device for controlled exchange of fluids with a living tree vascular system. The tree interfacing device comprises a body, at least one perforated conduit, a multi-layer membrane assembly, and one or more tissue-engaging surface structures. The tree interfacing device and associated membrane assembly provide multiple technical advantages over conventional tree injection, sap sampling, and vascular interfacing approaches. The tree interfacing device enables precise, bidirectional fluid exchange with xylem tissue at physiologically compatible flow rates under native xylem tensions. By mechanically matching the compliance of sapwood tissue and avoiding rigid probes or open conduits, the tree interfacing device minimizes vessel rupture, pit membrane damage, and uncontrolled leakage. The incorporation of a gas-separating membrane, tapered pore geometries, hydrophilic surfaces, and optional anti-embolism additives significantly reduces the risk of air seeding and cavitation.

### STATEMENT REGARDING FEDERALLY SPONSORED RESEARCH OR DEVELOPMENT

This invention was made with government support under NSF Award No. 2432240 awarded by the National Science Foundation (NSF). The government has certain rights in the invention.

### FIELD OF INVENTION

The present disclosure relates generally to tree-tissue interfacing systemic devices, and more particularly to devices and membrane-based systems configured to interface with xylem-parenchyma tissue within the sapwood of perennial trees for controlled exchange of fluids. The disclosed systems are configured to modulate physicochemical properties of introduced fluids relative to native sap conditions, enable sensing of tree-related parameters, and facilitate targeted delivery of substances throughout the tree canopy from a single implantation point while minimizing vascular damage and physiological stress. The system further enables precision and variable-rate nutrient management, supporting nutrient stewardship practices including application of the right nutrient source, at the right rate, at the right time, and at the right placement, thereby improving nutrient use efficiency. Additionally, the disclosed systems are configured to reduce or eliminate environmental exposure of fertilizers or other chemical substances by delivering such substances directly within the vascular transport network of the tree.

### BACKGROUND

Even small air ingress or mechanical mismatch in xylem conduits can result in irreversible embolism and loss of hydraulic function. For this reason, conventional approaches deliberately avoid porous or membrane-based interfaces at the xylem boundary. The ability to introduce substances into, or extract fluids from the xylem of living trees is of significant interest in agriculture, agriculture, arboriculture, forestry, and tree science. Applications include nutrient supplementation, delivery of growth regulators or protective agents, hydration management, tracer studies, and physiological monitoring. Xylem tissue, however, operates under negative pressure and is highly sensitive to mechanical disturbance, gas entry, and chemical imbalance.

Conventional approaches for xylem access include tree injection systems, infusion ports, pressurized syringes, gravity-fed reservoirs, wicks, and absorbent plugs inserted into drilled holes in sapwood. These systems are typically designed to introduce a bolus of liquid formulation or to permit passive uptake over a limited duration.

In some cases, wick-based or porous infusion elements are employed in an attempt to moderate delivery rates or maintain contact with sapwood tissue. Other systems rely on sealed injection fittings or valves intended to reduce leakage and contamination during administration.

Despite these developments, prior art systems generally suffer from one or more technical shortcomings when applied to xylem interfacing, precision, phytotoxicity and dosage delivery, no correlation or compatibility with tree physiology and anatomical responses, long term regular management without human intervention.

First, many existing devices fail to accommodate the mechanical compliance and microfluidics of living tree tissue, resulting in tissue tearing, seal loss, or DAMP's stress responses. Rigid or semi-rigid interfaces may induce stress concentrations that lead to callose deposition, lignification, or vessel occlusion over time, limiting to single use of method or interface site on tree trunk.

Second, conventional interfaces often permit uncontrolled air entry into the xylem, increasing the risk of embolism and cavitation. Once gas is introduced into a vessel network, fluid transport may be permanently impaired, limiting the duration and reliability of the interface.

Third, existing approaches typically lack selective control over ionic, osmotic, or molecular transport, allowing indiscriminate flow of sap constituents or applied substances. This limits their usefulness for targeted delivery, selective sampling, or real-time sensing of xylem and sap wood chemistry.

Fourth, known systems generally do not provide adaptive or stimulus-responsive regulation of flow. As a result, fluid exchange cannot be adjusted in response to changes in temperature, pH, sap tension, or environmental conditions, leading to either insufficient transport or excessive leakage.

Fifth, with current farming lands cultivated over centuries requiring fertilizers to meet most nutrient demands of perennial orchard trees, coming with limitations of soil acidifications and chemistry, foliar spray losses and air contamination, as these fertilizers are chemical substances prone to leaching and volatile effects when mixed in soils or sprayed, with severe environmental ecological impacts.

Finally, many prior art devices are designed for short-term use only, as prolonged interaction often triggers defensive tree stress responses, biofouling, or loss of hydraulic connectivity.

Therefore, there is a need for a tree-sap wood interfacing device that can establish a stable, minimally invasive interface with xylem parenchyma tissue while maintaining embolism resistance, mechanical compatibility, and selective, controllable fluid transport over extended periods. There is further a need for such a device to incorporate multi-layer membrane architectures capable of adaptive permeability, ionic selectivity, and biocompatible anchoring without compromising tree health.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a tree interfacing device for controlled exchange of fluids with a living tree vascular system. The tree interfacing device as a ‘synthetic root analog’, comprising a body, at least one perforated conduit, a multi-layer membrane assembly, and one or more tissue-engaging surface structures.

An embodiment of the first aspect wherein the body having a tissue-engaging surface structures acting as interface for fluid exchange and support anchoring or docking into xylem tissue of sapwood of a tree, mimicking symbiotic structures for nutrient exchange in roots. In one embodiment, a biocompatible polymeric matrix biomimicking fungal hyphae and Hartigarbuscule cuff symbiotic anchoring forming threading between cells, functionally mechanically stable in sapwood without shredding tissue. Membrane layer acts as lattice tissue to facilitate anchoring and fluid exchange thereby forming as a lattice with adjacent sapwood tissues having a swollen elastic modulus matched within a range of about 10 kPa to 500 kPa.

An embodiment of the first aspect wherein the tissue-engaging surface structures with micro channels of micro needle array or anchoring hydrogel fins for receiving or delivering a fluid. The tissue-engaging surface structures are configured for bi-directional fluid exchange, enabling both exchange of sap and delivery of nutrients or treatment of fluids, configured to defining a hydraulic permeability sufficient to regulate bidirectional fluid exchange between the tree interfacing device and xylem tissues at a rate of about 0.1-100 μL/s under native xylem tensions.

An embodiment of the first aspect wherein a perforated conduit is disposed on the body. The perforated conduit comprises tapered pores or capillary-like openings configured to promote directional fluid exchange. The perforated conduit sources and disperses fluid to multi-layer membrane from a fluid inlet.

An embodiment of the first aspect wherein the multi-layer membrane assembly is disposed between the tissue-engaging surface structures and the perforated conduit. The multi-layer membrane is implemented as a ‘Proton Motive force analog’ to drive transport of fluids. The multi-layer membrane assembly comprises at least one ion-selective membrane, at least one adaptive permeability membrane, a gel-based compliant matrix, and a gas-separating membrane as an anti gas and anti-pathogen membrane.

An embodiment of the first aspect wherein the ion-selective membrane and the at least one adaptive permeability membrane are arranged either concentrically or radially around the outer membrane. The ion-selective membrane comprises a cation-selective membrane, an anion-selective membrane, or a combination thereof.

An embodiment of the first aspect wherein the adaptive permeability membrane is responsive to one or more tree sap-related parameters. The adaptive permeability membrane is responsive to at least one pressure, pH, temperature, ionic concentration, or electrical stimulus. The adaptive permeability membrane comprises a thermos-responsive polymer exhibiting a lower critical solution temperature (LCST) between 20° C. to 35° C.

An embodiment of the first aspect wherein the gel-based compliant matrix is disposed adjacent to the ion-selective membrane and is configured to mechanically match xylem tissue. The gel-based compliant matrix comprises alginate, polyethylene glycol, polyvinyl alcohol, silica gel, or combinations thereof.

An embodiment of the first aspect wherein the gas-separating membrane is configured to inhibit entry of air or gas into the tree vascular system. The gas-separating membrane comprises a porous degassing membrane, gas-absorbing beads, anti-gas surfactants or a hydrophobic barrier layer, or a packed bed of hydrophilic beads embedded within a hydrogel matrix.

An embodiment of the first aspect wherein the multi-layer membrane assembly is configured to actively or passively modulate one or more physical or chemical properties of the fluid prior to entry into tree sap wood tissue. The multi-layer membrane assembly is configured to modulate the fluid properties in response to feedback derived from local xylem conditions to promote axial, radial and tangential transport of the fluid beyond the physical extent of the tissue-engaging surface structures. The multi-layer membrane assembly receives an inlet of external fluid having physicochemical properties modulated relative to native sap, including a pH at least 0.3 units higher, a temperature 2-5° C. higher, and selective ionic flux configured to generate electro-osmotic flow, thereby assigning fluid properties that enable the fluid, once introduced into the sapwood, to self-drive and achieve distribution throughout the entire canopy of the tree.

An embodiment of the first aspect wherein the tissue-engaging surface structures are disposed on an exterior of the body. The tissue-engaging surface structures are configured to mechanically stabilize the tree interfacing device within tree tissue. The tissue-engaging surface structures comprise micro-fins, ribs, barbs, surface texturing, or compliant protrusions configured to engage surrounding xylem tissue. The tissue-engaging surface structures having a length of 50-300 μm and a rake angle of 10° to 30°. The tissue-engaging surface structure is configured as mimicking symbiosomal membrane to form mechanical lattice with sapwood without fracturing cell walls.

An embodiment of the first aspect wherein the tree interfacing device enables controlled, long-term exchange of sap, nutrients, or analytes with the tree vascular system without inducing embolism or vascular blockage.

An embodiment of the first aspect wherein the tree interfacing device is configured to be implanted, partially embedded, or externally coupled to the tree vascular system. The tree interfacing device is configured for long-term operation exceeding a month without inducing vascular blockage. The tree interfacing device is configured to suppress embolism formation within xylem vessels during fluid exchange. The tree interfacing device is configured for use in perennial crops.

An embodiment of the first aspect wherein a method of interfacing with xylem tissue of a living tree for controlled exchange of fluids. At first step, an access opening is formed in sapwood of the living tree to access water conducting tissues. Next, the tree interfacing device is positioned within or adjacent to the sap wood such that the tissue-engaging surface structures contacts the xylem parenchyma tissue and the tissue-engaging surface structures mechanically anchor or dock the tree interfacing device within the sapwood.

Next, fluid communication is established between the xylem tissue and the tissue-engaging surface structures through the multi-layer membrane and perforated conduit assembly. Later, the bidirectional exchange of fluid is controlled between the xylem tissue and the perforated conduit through the multi-layer membrane assembly while a sealant module at entrance of the fluid inlet for air insulation and pathogen sealing. The interfacing is maintained under native xylem pressure conditions without inducing embolism or vascular blockage.

The fluid maybe a nutrient solution as liquid fertilizer or other biological solutions with diverse chemical and physical properties, supplemented to soil nutrition through root. The fluid from the fluid inlet maybe attached from irrigation system of perennials orchard acting as source to perforated conduit and thereby moving through the multi-layer membrane assembly modulating its physio-chemical properties accordingly to sap flowing in contact tissue for achieving best possible displacement with microfluidics to diffuse into sap wood via outer membrane.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a diagram of a tree interfacing device for controlled exchange of fluids with a living tree vascular system, in accordance with embodiments of the invention.

FIG. 2 illustrates a schematic perspective view of the tree interfacing device, in accordance with embodiments of the invention.

FIG. 3 illustrates a schematic perspective view of a tissue-engaging surface structures, in accordance with embodiments of the invention.

FIG. 4 illustrates a schematic perspective view of the multi-layer membrane assembly with ion-selective membrane and other functional membranes for modulating physicochemical properties of fluid in accordance with embodiments of the invention.

FIG. 5 illustrates a flowchart for method of interfacing with xylem tissue of a living tree for controlled exchange of fluids, in accordance with embodiments of the invention.

FIG. 6 illustrates a schematic perspective view of the tree interfacing device positioned within sapwood of a tree, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

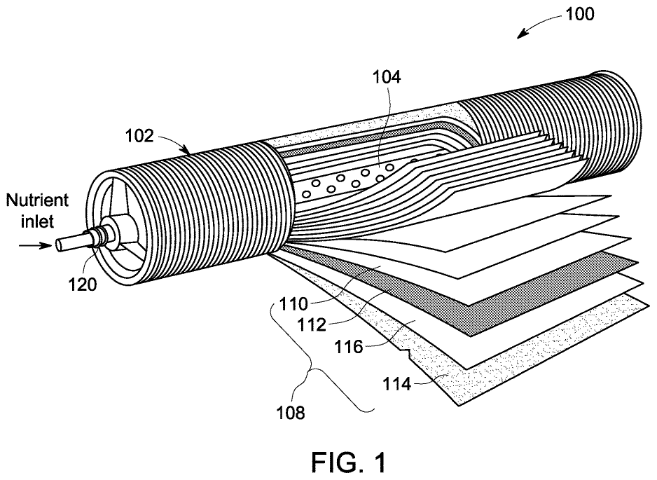

FIG. 1 refers to a diagram of a tree interfacing device 100 for controlled exchange of fluids with a living tree vascular system. The tree interfacing device 100 comprises a body 102, a perforated conduit 104, a multi-layer membrane assembly 108, and one or more tissue-engaging surface structures 106. The systemic tree interfacing device 100 for systemic precision agriculture with perfect implementation of right nutrient source, at the right rate, at the right time, and at the right placement (4R's) of nutrient management by controlled exchange of fluids with a living tree sap wood vascular system.

In one embodiment, the tree interfacing device 100 is for synthetic root analog functionality mimicking with its membrane and micro electromechanical systems (MEMS) implementing mimicking of symbiosomal membrane providing selective ion transport, ion-gradient-driven gating, and controlled microenvironment formation for regulated exchange with sapwood.

In one embodiment, the tree interfacing device 100 is configured to be implanted, partially embedded, or externally coupled to the tree sap wood conducting system thereby avoiding any kind of environmental exposure of chemicals in form of fertilizer or other regulators for tree crop management. The tree interfacing device 100 is configured to suppress embolism formation with sealant and anti-gas surfactants. The tree interfacing device 100 is configured for use in perennials, orchards and trees for agriculture purposes for holistic nutrient and health management with precision in dosage of chemicals as needed by tree and directly into tree hydraulic distribution system bypassing limitations of genetic or root-soil relations for intake of nutrients.

In one embodiment, the tree interfacing device 100 is configured to interface with xylem-parenchyma tissue within the sapwood of perennial trees for controlled exchange of fluids. The tree interfacing device 100 is configured to modulate physicochemical properties of introduced fluids relative to native sap conditions, enable sensing of tree-related parameters, and facilitate targeted delivery of substances throughout the tree canopy from a single implantation point while minimizing vascular damage and physiological stress. The tree interfacing device 100 further enables precision and variable-rate nutrient management, supporting nutrient stewardship practices including application of the right nutrient source, at the right rate, at the right time, and at the right placement, thereby improving nutrient use efficiency. Additionally, the tree interfacing device 100 is configured to reduce or eliminate environmental exposure of fertilizers or other chemical substances by delivering such substances directly within the vascular transport network of the tree.

The multi-layer membrane assembly 108 is a gating module. The tissue-engaging surface structures 106 form an anchoring module. The multi-layer membrane assembly 108 is formed by plurality of layered membranes.

As used herein, ‘radially outward,’ ‘radially inward,’ ‘axial,’ and ‘circumferential’ are defined relative to the longitudinal axis of the perforated conduit 104. The perforated conduit 104 is inner most which is connected to a fluid inlet 120 and disperses fluid to out layers via the multi-layer membrane assembly 108.

In one embodiment, the tree interfacing device 100 implanted in tree is configured to distribute the fluid entering through the fluid inlet 120 to distribute across an entire tree canopy with a time period depending on fluid ion mobility rates and environmental factors.

In one embodiment, the tree interfacing device 100 configured for controlled fluid exchange with vascular tree tissue, particularly sapwood xylem. The tree interfacing device 100 is adapted for insertion into a lateral bore drilled deep to few mm typically 1-3 inches depending on target specie to access sapwood and is configured to regulate fluid delivery and/or sampling while minimizing embolism formation, tissue trauma, and tree defense signaling.

In one embodiment, the anchoring exchange module 102 having plurality of tissue-engaging surface structures 106 as an outer layer and an inner flow-communication region configured to be positioned within or adjacent to xylem tissue of a tree. In one embodiment, a biocompatible polymeric matrix forming at least a portion of the body 102 and having a swollen elastic modulus matched to adjacent sapwood tissues within a range of about 10 kPa to 500 kPa.

In one embodiment, the tissue-engaging surface structures 106 as the outer layer extends along a longitudinal axis of the body 102 for receiving or delivering a fluid. The tissue-engaging surface structures 106 are configured for bi-directional fluid exchange, enabling both extraction of sap and delivery of nutrients or treatment of fluids. The tissue-engaging surface structures 106 are configured to defining a hydraulic permeability sufficient to regulate bidirectional fluid exchange between the tree interfacing device 100 and xylem tissues at a rate of about 0.1-100 L/s under native xylem tensions.

The perforated conduit 104 is an internal conduit, the tissue-engaging surface structures 106 are for anchoring and fluid transport with micro needles or fins.

In one embodiment, the tissue-engaging surface structures 106 are disposed on the outer surface of the body 102. The tissue-engaging surface structures 106 are configured for enabling radial fluid communication between the perforated conduit 104 and surrounding tree tissue. The tissue-engaging surface structures 106 comprise anchoring/docking module to affix in sap wood with micro needles, micro fins, tapered pores or capillary-like openings, depending on the hardness of wood of tree species and configured to promote directional fluid exchange. The tissue-engaging surface structures 106 provide structural integrity affixing circumferentially into the bore hole to attain maximum surface area contact with sap wood thereby providing maximum fluid exchange axially and radially to and from tree sap wood tissues. The tissue-engaging surface structures 106 is compatible with adjacent sap wood tissue and affixes with least stress triggers for long term gating of fluids.

The tissue-engaging surface structures 106 may include biomimetic chemical grafts configured to reduce tree damage-associated molecular pattern (DAMP) signaling. Exemplary surface chemistries include: pectin-mimetic grafts enriched in galacturonic acid moieties, catechol-based ligands (e.g., dopamine derivatives), and boronate-containing groups capable of reversible bonding with cis-diols. These chemistries form reversible, non-covalent interactions with cellulose hydroxyl groups and pectin components of tree cell walls, promoting stable yet non-injurious adhesion. The tissue-engaging surface structures 106 also functions as a feedback module, providing hydraulic communication comprising of smart hydrogels to gating the multi-layer membrane assembly 108 by sensing and analyzing critical physio-chemical parameters of the sap pH, Temperature, ionic flux and other microfluidic parameters flowing in adjacent tissues and relaying to the multi-layer membrane assembly 108. The tissue-engaging surface structures 106 is configured to detect sapwood pH, ionic strength, or redox state and adjusts the multi-layer membrane assembly 108 to regulate fluid exchange, thereby forming a closed-loop gating system.

In one embodiment, the multi-layer membrane assembly 108 receives an inlet of external fluid having physicochemical properties modulated relative to native sap, including a pH at least 0.3 units higher, a temperature 2-5° C. higher, and selective ionic flux configured to generate electro-osmotic flow, thereby assigning fluid properties that enable the fluid, once introduced into the sapwood, to self-drive and achieve distribution throughout the entire canopy of the tree.

In some embodiments, the perforated conduit 104 is further disposed on the multi-layer membrane assembly 108.

In one embodiment, the multi-layer membrane assembly 108 is disposed between the perforated conduit 104 and the surrounding tree tissue. The multi-layer membrane assembly 108 comprises at least one ion-selective membrane 110, at least one adaptive permeability membrane 112, a gel-based compliant matrix 114, and a gas-separating membrane 116.

In exemplary embodiments, the multi-layer membrane assembly 108 is configured as a generally cylindrical sleeve surrounding or partially surrounding the perforated conduit 104. The sleeve may have an outer diameter between approximately 2 mm and 6 mm and a longitudinal length between approximately 5 mm and 20 mm, enabling placement within a shallow lateral bore drilled into active sapwood above ground level in the trunk.

The multi-layer membrane assembly 108, having the fluid inlet 120 connected to the perforated conduit 104, is configured to receive external fluid and to operate with smart feedback based on current sap physicochemical properties. The feedback regulates the modulating parameters of each layer of the multi-layer membrane assembly to optimize microfluidic flow within the sapwood relative to the native sap flow. The modulation is based on established microfluidic principles including surface charge effects, electro-osmotic flow (EOF), and interfacial mixing induced by controlled increases in pH, ionic gradients, and temperature gradients. The multi-layer membrane assembly 108 performs fluid physio-chemical modulation layer by layer relative to sap flowing in tissues adjacent well withing boundary threshold to not trigger any stress responses or cell damage which are established in research data on various species

In experimental observations, such interfaces may exhibit low callose deposition and minimal tyloses formation even after weeks following implantation.

In one embodiment, the ion-selective membrane 110 and the at least one adaptive permeability membrane 112 are arranged either concentrically or radially around the perforated conduit 104. The ion-selective membrane 110 comprises a cation-selective membrane 110A, an anion-selective membrane 110B, or a combination thereof.

In one embodiment, the adaptive permeability membrane 112 is responsive to the tree-related parameters. The adaptive permeability membrane 112 is responsive to at least one of pressure, pH, temperature, ionic concentration, or electrical stimulus. The adaptive permeability membrane 112 comprises a thermos-responsive polymer exhibiting a lower critical solution temperature (LCST) between 20° C. to 35° C.

As used herein, the term “tree-related parameters” refers to physicochemical or microfluidic parameters associated with sap flow within xylem tissue of a tree. Such parameters may include, but are not limited to, sap pressure, sap flow rate, temperature, pH, ionic concentration, osmotic potential, dissolved gas concentration, electrical conductivity, or hydraulic resistance. These parameters may be detected directly by sensing elements disposed within the tree interfacing device 100 or indirectly inferred from fluid flow conditions within the multi-layer membrane assembly 108.

In certain embodiments, the tree interfacing device 100 further includes one or more sensing elements disposed within or adjacent to the tissue-engaging surface structures 106 or the multi-layer membrane assembly 108. The sensing elements are configured to detect one or more tree-related parameters that comprise, but are not limited to, sap pressure, temperature, pH, or ionic concentration. Signals generated by the sensing elements are communicated to a control module configured to modulate permeability of the adaptive permeability membrane 112 or ionic transport properties of the ion-selective membrane 110. The modulation may occur through thermal actuation, electro-osmotic biasing, osmotic pressure adjustment, or stimulus-responsive polymer transitions, thereby establishing a closed-loop regulation of fluid exchange between the tree interfacing device 100 and the tree vascular system.

In one embodiment, the gel-based compliant matrix 114 is disposed adjacent to the ion-selective membrane 110. The gel-based compliant matrix 114 is configured to mechanically match xylem tissue. The gel-based compliant matrix 114 comprises alginate, polyethylene glycol, polyvinyl alcohol, silica gel, or combinations thereof.

In one embodiment, the gas-separating membrane 116 is configured to inhibit entry of air or gas into the tree vascular system. The gas-separating membrane 116 comprises a porous degassing membrane, gas-absorbing beads, or a hydrophobic barrier layer, or a packed bed of hydrophilic beads embedded within a hydrogel matrix.

In one embodiment, the multi-layer membrane assembly 108 is functionally coupled to perforated conduit 104. The multi-layer membrane assembly 108 is configured to actively or passively modulate one or more physical or chemical properties of the fluid prior to entry into tree tissue. The multi-layer membrane assembly 108 is configured to modulate the fluid properties in response to feedback derived from local xylem conditions so as to promote longitudinal transport of the fluid beyond a physical extent of the perforated conduit 104.

In one embodiment, the tissue-engaging surface structures 106 are disposed on an exterior of the body 102. The tissue-engaging surface structures 106 are configured to mechanically stabilize the tree interfacing device 100 within tree tissue. The tissue-engaging surface structures 106 comprise at least one of micro-fins, ribs, barbs, surface texturing, and compliant protrusions. The tissue-engaging surface structures 106 are configured to engage surrounding xylem tissue. The tissue-engaging surface structures 106 having a length of 50-300 μm and a rake angle of 10° to 30°. The tissue-engaging surface structures 106 is configured to mechanically interlock with intercellular spaces and middle lamella regions of sapwood without fracturing cell walls.

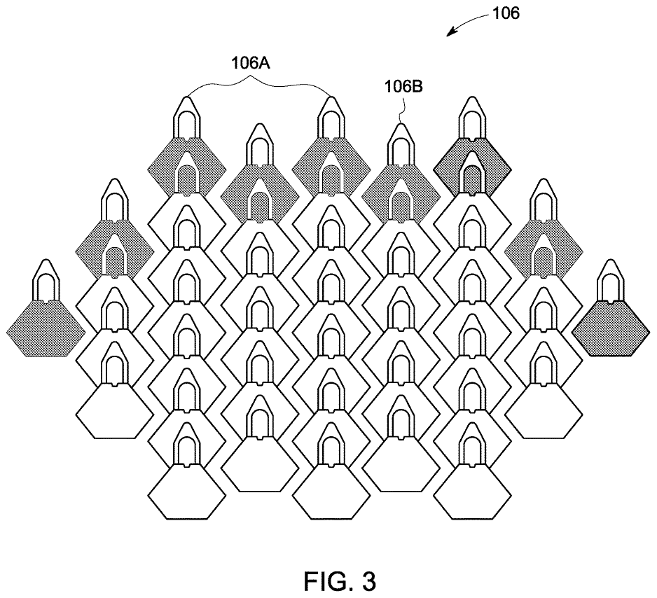

In certain embodiments, inner anchoring of the tree interfacing device 100 within xylem parenchyma tissue is achieved through compliant mechanical engagement rather than tissue cutting. The body 102 includes the tissue-engaging surface structures 106 in the form of micro-fins array 106A (as shown in FIG. 3) that are configured to displace and lodge within intercellular spaces and middle lamella regions of sapwood tissue, thereby transferring load without forming continuous cell wall fracture planes. The body 102 comprises a cellulose nanofiber (CNF)-reinforced hydrogel matrix selected to match local xylem modulus, thereby reducing shear-induced tearing during micromotion.

In exemplary embodiments, the body 102 undergoes controlled radial swelling of approximately 2% to 8%, generating circumferential contact pressure sufficient to maintain sealing without inducing overpressure. Surface chemistries associated with the tissue-contacting regions include pectin-mimetic grafts and catechol- or boronate-containing functional groups that form reversible interactions with cellulose hydroxyl groups and pectin cis-diol moieties. In operation, the anchoring system maintains sealing under daily micromotion strains of approximately +0.1% to +0.3% and exhibits low callose deposition and minimal tyloses formation within approximately 24 to 72 hours following imprecation.

In one embodiment, the tree interfacing device 100 enables controlled, long-term exchange of sap, nutrients, or analytes with the tree vascular system without inducing embolism or vascular blockage.

In one embodiment, the tree interfacing device 100 comprises the fluid inlet 120 extending through the body 102 along a longitudinal axis from a proximal end toward a distal end of the tree interfacing device 100 and terminating at or near a distal tip configured for interfacing with tree vascular tissue. The fluid inlet 120 defines at least one outer conduit configured to receive, deliver, or exchange a fluid with the tree vascular system.

The tree interfacing device 100 further comprises a sealing member 124 operatively coupled to the fluid inlet 120, wherein the sealing member 124 is configured to provide a fluid-tight interface between the fluid inlet 120 and bore hole. The sealing member 124 inhibits unintended leakage of fluid, pathogen entry and prevents ingress of air or gas into the perforated conduit 104 during operation.

In certain embodiments, the sealing member 124 comprises an elastomeric, compliant, or deformable material configured to accommodate pressure fluctuations arising from native xylem tension, fluid property modulation, or external handling. The sealing member 124 may further function as a pressure-isolating or decoupling element, enabling stable fluid delivery through the fluid inlet 120 without inducing embolism or disruption of native sap flow within the tree vascular system.

In some embodiments, the fluid inlet 120 is configured to permit bidirectional fluid flow, including extraction of sap from the tree vascular system and delivery of nutrients, treatment agents, or diagnostic fluids into the tree tissue. In such embodiments, the sealing member 124 is configured to maintain sealing integrity during both inflow and outflow conditions.

In one embodiment, the tree interfacing device 100 is configured to be implanted, partially embedded, or externally coupled to the tree vascular system. The tree interfacing device 100 is configured for long-term operation, exceeding 24 hours to months without inducing vascular blockage. The tree interfacing device 100 is configured to suppress embolism formation within xylem vessels during fluid exchange. The tree interfacing device 100 is configured for use in most perennials and woody trees.

In another embodiment, the tree interfacing device 100 comprises at least one sensor (not shown) configured to measure a parameter selected from pressure, temperature, pH, ion concentration, sap flow rate, or dissolved gas content. The sensor is embedded within or adjacent to the multi-layer membrane assembly 108.

In one embodiment, the tissue-engaging surface structures 106 further comprises one or more sensing and receptor elements (not shown) configured to detect local xylem parameters, including pressure, sap flow behaviour, and chemical or ionic conditions, and to generate feedback signals representative of local vascular transport dynamics. The tissue-engaging surface structures 106 are configured as mimicking symbiosomal membrane to form mechanical lattice with sapwood without fracturing cell walls.

The multi-layer membrane assembly 108 is configured to dynamically tune one or more physical or chemical properties of a delivered fluid based on feedback data received from the sensing and receptor elements. In operation, the multi-layer membrane assembly 108 promotes circumferential displacement of the fluid within the sapwood by implementing Proton-Motive-Force (PMF) principles, thereby enhancing radial and longitudinal distribution of the fluid within surrounding xylem tissue. The multi-layer membrane assembly 108 comprising a synthetic proton-motive-force (PMF) analog gating layer disposed between the tissue-engaging surface structures 106 and the perforated conduit 104 from inlet to source fluid into it.

The multi-layer membrane assembly 108 is configured to modulate at least one physicochemical property of the fluid prior to entry into tree tissue with dynamic response capability with correlation to the tissue-engaging surface structures 106.

In another embodiment, the tree interfacing device 100 further comprising a control unit configured to adjust membrane permeability or flow rate based on sensed tree parameters. The control unit is configured to operate in a closed-loop feedback mode.

A bore hole of at least 15 mm diameter and few inches deep based on specie for access to sap wood, drilled perpendicular to tree trunk few inches above the ground, the tree interfacing device 100 is configured to be positioned within or adjacent to sapwood xylem tissue of a tree. The tissue-engaging surface structures 106 as outermost layers with affixing/docking into sap wood for maximum contact surface area and least stress responses from tree comprising of micro needles, micro fins, electro spun membranes based on rigidity of wood across species mimicking the symbiosomal membrane lattice or hyphae or arbuscules for regular nutrient or sap or other fluid exchange.

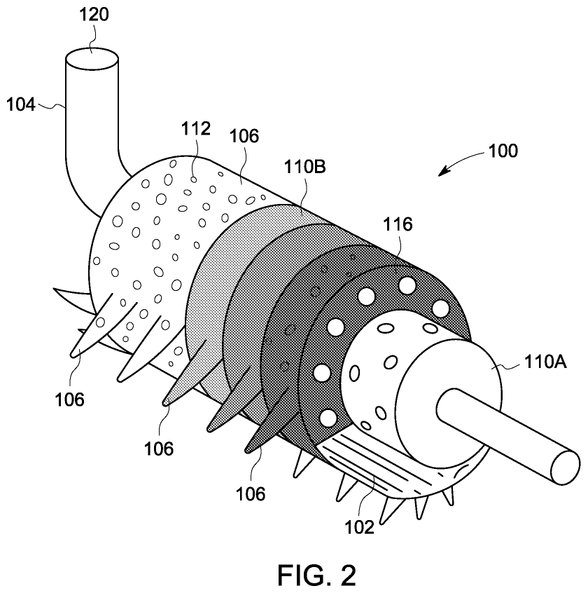

FIG. 2 refers to a schematic perspective view of the tree interfacing device 100. In one embodiment, an outer tissue-contacting surface of the body 102 comprises a bio-integrative surface region configured to promote low-damage adhesion, hydration shell maintenance, and controlled wetting at the xylem interface. The outer tissue-contacting surface may comprise a zwitterionic polymeric coating disposed over pectin-mimetic grafted structures on a porous primer layer. The surface region may have an effective thickness of about 0.1-1 μm and exhibits a swollen elastic modulus within about 50-300 kPa. The surface region is configured to maintain a contact angle of about 20-40° and to reduce callose deposition or lignification relative to untreated control interfaces during implanted periods of at least 7-14 days.

In one embodiment, the ion-selective membrane 110 comprises one or more ion-selective layers arranged concentrically or radially around the perforated conduit 104. The ion-selective membrane 110 may include a cation-selective membrane 110A formed from sulfonated polymeric materials and/or an anion-selective membrane 110B formed from quaternized polymeric materials. Each ion-selective membrane layer may have a thickness of about 0.2-1 μm and a fixed charge density within about 0.5-2 mmol/g. The ion-selective membrane 110 is configured to provide selective ionic transport and may exhibit permselectivity ratios in a range of about 1.5-3.0 for monovalent ions present in xylem sap.

Optional embodiments may further enable electro-osmotic modulation of fluid transport when an electrical stimulus is applied, without exceeding microampere to milliampere current levels.

In one embodiment, the adaptive permeability membrane 112 is disposed adjacent to the ion-selective membrane 110 and is configured to dynamically regulate fluid permeability in response to tree-related parameters. The adaptive permeability membrane 112 may be responsive to pressure, temperature, pH, ionic concentration, or electrical stimulus. In one embodiment, the adaptive permeability membrane 112 comprises a thermoresponsive polymer exhibiting a lower critical solution temperature between about 20° C. and 35° C., enabling reversible modulation of permeability in response to local temperature changes of about +1-2° C.

In one embodiment, the gel-based compliant matrix 114 is disposed adjacent to the ion-selective membrane 110 and is configured to mechanically match xylem tissue while accommodating pressure fluctuations and tissue motion. The gel-based compliant matrix 114 may comprise alginate, polyethylene glycol, polyvinyl alcohol, silica gel, cellulose nanofiber-reinforced hydrogels, or combinations thereof, and may have a swollen elastic modulus within about 100-500 kPa. The gel-based compliant matrix 114 may further serve as a carrier matrix for embedded structures associated with gas separation or embolism suppression.

In one embodiment, the multi-layer membrane assembly 108, and particularly the gel-based compliant matrix 114, may be configured to undergo controlled radial swelling after insertion. In exemplary embodiments, swelling may be limited to approximately 2-8% in radial dimension, thereby generating circumferential contact pressure sufficient to maintain sealing and positional stability without inducing overpressure or vessel collapse.

The gel-based compliant matrix 114 comprises a biocompatible polymer network having an effective elastic modulus selected to approximate that of adjacent sapwood tissue. In exemplary embodiments, the swollen modulus of the multi-layer membrane assembly 108 may fall within a range of approximately 10 kPa to 500 kPa, and more preferably within +30% of the locally measured modulus of host xylem tissue. This mechanical matching reduces micromotion-induced shear, minimizes tissue damage, and supports long-term integration.

In one embodiment, the gas-separating membrane 116 is disposed radially outward within the multi-layer membrane assembly 108 and is configured to inhibit entry of air or gas into the tree vascular system. The gas-separating membrane 116 may comprise a porous degassing membrane, a hydrophobic barrier layer, gas-absorbing beads, or a packed bed of hydrophilic beads embedded within the gel-based compliant matrix 114. The gas-separating membrane 116 is configured to suppress gas passage under xylem tensions of up to about 30 kPa while maintaining hydraulic continuity.

In one embodiment, the tissue-engaging surface structures 106 are disposed on the body 102 and comprises tapered pores or capillary-like openings configured to promote directional fluid exchange between the perforated conduit 104 and surrounding tree tissue. The tapered pores may have inlet diameters of about 10-20 μm, throat diameters of about 2-5 μm, and taper angles of about 5-15°, thereby providing passive pressure-responsive flow regulation and hysteresis under native sap tension fluctuations.

In one embodiment, the tissue-engaging surface structures 106 are disposed on an exterior of the body 102 and are configured to mechanically stabilize the tree interfacing device 100 within tree tissue. The tissue-engaging surface structures 106 may comprise the micro-fins array 106A having a length of about 50-300 μm, a tip radius of about 5-30 μm, a rake angle of about 10-30°, and a spacing of about 100-400 μm. The tissue-engaging surface structures 106 are configured to provide sealing pressures of at least about 10 kPa after swelling while avoiding continuous cell wall fracture.

FIG. 3 refers to a schematic perspective view of the tissue-engaging surface structures 106. In one embodiment, the tissue-engaging surface structures 106 are configured to provide inner anchoring within xylem parenchyma by a displacement-based engagement mechanism. The tissue-engaging surface structures 106 comprise the micro-fins array 106A that is configured to displace, rather than cut, adjacent tree cell walls, thereby lodging into intercellular spaces and middle lamella regions of sapwood tissue. This displacement-based anchoring reduces shear-induced tearing and preserves vascular integrity.

In one embodiment, the body 102 comprises a cellulose nanofiber (CNF)-reinforced hydrogel matrix configured to mechanically match local xylem tissue. The CNF-reinforced hydrogel exhibits a swollen elastic modulus selected to minimize shear stress at the interface while permitting controlled deformation during insertion and operation.

In one embodiment, the body 102 is configured to undergo controlled radial swelling of about 2-8% after implanted, thereby generating circumferential contact pressure sufficient to maintain sealing and positional stability without inducing overpressure or fracture of xylem cell walls.

In one embodiment, surface chemistry of the body 102 and/or tissue-engaging surface structures 106 comprises pectin-mimetic grafts and reversible binding motifs selected to interact with tree cell wall components. Such motifs may include catechol-based or boronate-based functional groups configured to form reversible interactions with cellulose hydroxyl groups and pectin cis-diol moieties, thereby enhancing anchoring stability while permitting gradual tissue accommodation.

In one embodiment, the tissue-engaging surface structures 106 and associated surface chemistries are configured to maintain a functional seal under daily micromotion strains of about +0.1-0.3%, while exhibiting reduced bioreactivity as indicated by low callose deposition and minimal tyloses formation in adjacent xylem tissue within 24-72 hours after implanted.

In one embodiment, the tissue-engaging surface structures 106 may include electrospun, carbon nanotube (CNT), or hydrogel-based symbiotic lattice structures configured to mimic biological anchoring mechanisms. In alternative embodiments, the tissue-engaging surface structures 106 comprises the micro-fins array 106A or an array of micro-needles. The micro-fins array 106A is particularly suited for use in tree species exhibiting rigid or highly lignified sapwood tissues. This alternative anchoring configuration is particularly suited for applications in which compliant or gel-based anchoring structures alone are insufficient to achieve stable fixation of the tree interfacing device 100.

The micro-fins array 106A is configured to penetrate and bypass tougher outer tissues and seat directly within the more hydraulically active sapwood. In this configuration, the tissue-engaging surface structures 106 establishes a mechanical interlock between the tree interfacing device 100 and the sapwood. This mechanical interlock provides stable fixation against bark movement, wind-induced motion, and other external perturbations, while defining a controlled contact area for fluid exchange with xylem sap. Each micro-fins 106A includes a tapered and rounded distal tip 106B configured to reduce stress concentration within lignified tissue. The tapered geometry minimizes crack initiation and suppresses crack propagation, thereby reducing the likelihood of catastrophic fracture lines during insertion and long-term implanted. The micro-fins array 106A is fabricated from biocompatible, low-corrosion materials, including stainless steel or titanium. In exemplary embodiments, the micro-fins array 106A have dimensions corresponding to approximately 33-gauge needle profiles, thereby providing sufficient mechanical strength for insertion while minimizing tissue disruption and vascular damage.

In one embodiment, the tree interfacing device 100 is configured to operate within a total steady-state flow band of about 0.1-100 μL/s across the multi-layer membrane assembly 108, with transient burst operation up to about 100 μL/s for durations not exceeding about 10 minutes, without inducing embolism or vascular blockage. In one embodiment, passive pressure regulation is provided by the tissue-engaging surface structures 106 comprise tapered pores configured to open at pressure differentials of about 10-30 kPa. The gas-separating membrane 116 is configured to maintain embolism suppression and gas exclusion under pressure differentials up to about 30 kPa. In one embodiment, the ion-selective membrane 110 provides effective cation-to-anion or anion-to-cation bias factors in a range of about 1.5-3.0, wherein selectivity may be tuned by membrane area ratios, fixed charge density, or membrane arrangement within the multi-layer membrane assembly 108.

In one embodiment, the tissue-engaging surface structures 106 are configured to promote dropletization of delivered fluids, yielding a Sauter mean droplet diameter (D32) of about 10-30 μm and a lateral spread into surrounding xylem tissue that is at least about 1.5 times greater than that achieved without dropletization under equivalent pressure differentials. In one embodiment, thermal modulation provided by the adaptive permeability membrane 112 enables local temperature adjustments of about +1-2° C., thereby shifting membrane permeability windows by about 10-30% for thermoresponsive or pH-responsive polymeric components. The adaptive permeability membrane 112 and/or gel-based compliant matrix 114 may define a nanoporous architecture generated by phase separation, porogen leaching, cryogelation, or related techniques.

In exemplary embodiments mean pore sizes may range from 20 nm to 800 nm, tortuosity may range from 1.5 to 3.5, and pore size distributions may be tuned via crosslink density or porogen content.

In one embodiment, the outer tissue-contacting surface of the body 102 maintains stable hydrophilicity characterized by a contact angle of about 20-40° for at least about 30 days of implanted, while preventing gas breakthrough under native xylem sap tensions. In one embodiment, quality control verification of the tree interfacing device 100 includes evaluation of wetting behavior and capillary performance by contact angle measurement and capillary opening pressure analysis, and verification of tapered pore geometry by microscopic inspection or replica casting techniques. In one embodiment, ionic performance of the ion-selective membrane 110 is verified by fixed charge density measurement, permselectivity testing, and open-circuit potential response to controlled ionic activity variations.

In one embodiment, embolism suppression performance of the gas-separating membrane 116 is verified by gas intrusion testing under pressure differentials up to about 30 kPa and by imaging-based assessment of internal structure distribution. In one embodiment, mechanical performance of the body 102 and the tissue-engaging surface structures 106 is verified by pull-out force testing and seal integrity testing under hydrated conditions representative of tree sapwood.

In another embodiment, the tree interfacing device 100 comprises a membrane sleeve forming part of the multi-layer membrane assembly 108, positioned to directly contact xylem parenchyma tissue, while control elements are confined within a supporting housing forming part of the body 102. In some embodiments, the tissue-engaging surface structures 106 comprise a plurality of micro-anchors, fins, ridges, or expandable polymer protrusions extending radially from the membrane sleeve. These tissue-engaging surface structures 106 are configured to displace rather than cut xylem cell walls, lodging within intercellular spaces and the middle lamella.

In an exemplary embodiment, the micro-anchors may have lengths between 50 μm and 300 μm, tip radii between 5 μm and 30 μm, and rake angles between 10° and 60° relative to the surface of the body 102. Such geometries promote reversible mechanical interlocking while avoiding fracture or shear tearing of xylem tissue.

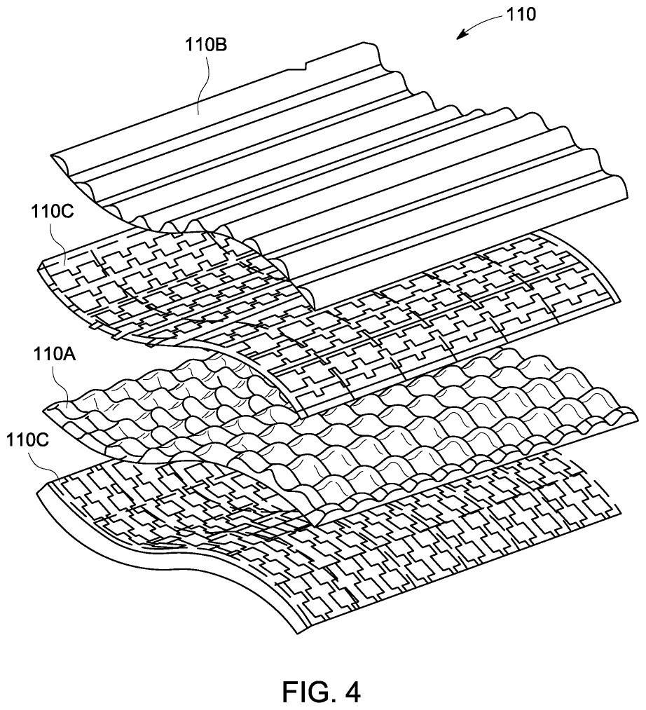

FIG. 4 refers to a schematic perspective view of the ion-selective membrane 110. The ion-selective membrane 110 disposed between the perforated conduit 104 and the tissue-engaging surface structures 106. The ion-selective membrane 110 is configured to regulate transport of ionic species between the tree interfacing device 100 and xylem sap, while permitting bulk fluid exchange within defined hydraulic limits.

In one embodiment, the ion-selective membrane 110 comprises the cation-selective membrane 110A, the anion-selective membrane 110B, and one or more electrode structures 110C. The cation-selective membrane 110A is configured to preferentially permit passage of positively charged ions, while restricting negatively charged ions, and the anion-selective membrane 110B is configured to preferentially permit passage of negatively charged ions, while restricting positively charged ions. In certain embodiments, the electrode structures 110C may be implemented as flexible conductive layers, such as PEDOT: PSS films or indium-tin-oxide (ITO) coated polymer substrates, laminated onto or embedded within the synthetic membrane assembly. The electrode structures 110C are configured to apply a low-level electrical potential, for example in a range of tens to hundreds of millivolts, to bias ionic transport across the ion-selective membranes without inducing electrolysis or tissue damage.

In one embodiment, the electrode structures 110C are disposed adjacent to the ion-selective membrane 110, electrically coupled thereto through an intervening polymeric or hydrogel layer, such that the electrode structures do not interrupt ionic permselectivity or fluid continuity.

In one embodiment, the electrode structures 110C are arranged as thin, planar, mesh-like, or patterned conductive layers positioned adjacent to or embedded within the ion-selective membrane 110. The electrode structures may be electrically isolated from the perforated conduit 104 and from surrounding xylem tissue by intervening polymeric or hydrogel layers.

In some embodiments, the multi-layer membrane assembly 108 further comprises one or more electrode structures 110C configured to cooperate with the cation-selective membrane 110A and the anion-selective membrane 110B to enable electrokinetic modulation, ion-selective gating, sensing, or degassing assistance.

The electrode layers are embedded within or adjacent to the layered membranes of the multi-layer membrane assembly 108 such that applied electrical fields remain confined within the membrane assembly and the perforated conduit 104.

In one preferred embodiment, the multi-layer membrane assembly 108 is arranged as an axial multilayer stack, in which the cation-selective membrane 110A is positioned closer to the inflow side of the perforated conduit 104, the anion-selective membrane 110B is positioned downstream relative to the cation-selective membrane 110A, and the electrode structures 110C are positioned outside the ion-selective membrane 110. A first electrode structure 110C is positioned on a side of the cation-selective membrane 110A opposite the perforated conduit 104, and a second electrode structure 110C is positioned on a side of the anion-selective membrane 110B opposite the perforated conduit 104. In this configuration, the ion-selective membrane 110 act as electrical and chemical barriers between the electrodes and the xylem interface, preventing electrochemical damage to tree tissue.

In alternative embodiments, the electrode layers may be interleaved within the layered membranes of the multi-layer membrane assembly 108, such that the first electrode structure 110C is positioned between the cation-selective membrane 110A and the adaptive permeability membrane 112, and the second electrode structure 110C is positioned between the anion-selective membrane 110B and the gel-based compliant matrix 114. In such embodiments, the electrode layers are encapsulated within electrically insulating hydrogel regions, preventing direct ionic shorting while enabling controlled electric field gradients across the ion-selective membrane 110.

In further embodiments, the electrode structures 110C may be configured as coaxial or circumferential electrodes, extending radially around the perforated conduit 104 or embedded within the body 102.

In an exemplary embodiment, an inner electrode layer may be formed as a thin conductive coating on an inner wall of the flow conduit 104, and an outer electrode layer may be formed as a circumferential ring embedded within the multi-layer membrane assembly 108. This arrangement generates radially directed electric fields across the ion-selective membrane 110, enabling electroosmotic flow control and selective ion migration.

The electrode structures 110C may comprise any tree-compatible conductive material, including but not limited to conductive polymers (e.g., PEDOT: PSS, polypyrrole), carbon-based materials (e.g., graphene, carbon nanotube networks, carbon ink), thin metal films (e.g., gold, platinum) encapsulated within polymer matrices, or ionic liquid-impregnated polymer layers. In preferred embodiments, the electrode layers are flexible, corrosion-resistant, and mechanically compliant, with thicknesses ranging from approximately 50 nm to 50 μm, so as not to disrupt the compliance of the multi-layer membrane assembly 108. The electrode structures 110C are configured to operate under low-voltage, low-current conditions suitable for biological systems. Exemplary operating parameters include electric field strengths between 0.1 V/cm and 10 V/cm, duty-cycled or pulsed operation with on-times less than 10 minutes, and current densities limited to prevent electrolysis within the xylem interface. In passive embodiments, the electrodes may remain electrically floating and function solely as ionic charge collectors or field-shaping elements.

In one embodiment, the electrode structures 110C may enable one or more of the following functions electrokinetic gating, electroosmotic assist, dynamic permselectivity tuning, degassing enhancement, and sensing.

In some embodiments, the electrode layers are electrically isolated from direct contact with xylem tissue by one or more of the ion-selective membrane 110, adaptive permeability membrane 112, or gel-based compliant matrix 114. This layered isolation ensures avoidance of direct electrochemical reactions at the tissue interface, preservation of low DAMP signaling, and long-term stability of tree-electrode interactions.

In one embodiment, the ion-selective membrane 110 is formed as a thin polymeric membrane comprising fixed ionic charge groups distributed within a polymer matrix, thereby establishing permselective ion transport under native xylem pressure gradients. The ion-selective membrane 110 may be supported on or integrated with a porous sublayer to provide mechanical stability without substantially increasing flow resistance.

In one embodiment, the ion-selective membrane 110 is arranged concentrically or radially around the perforated conduit 104 and is in fluid communication with the tissue-engaging surface structures 106, such that ions exchanged across the ion-selective membrane 110 are delivered to or extracted from surrounding xylem tissue through tapered pores or capillary-like openings.

In one embodiment, the ion-selective membrane 110 is configured to provide an effective ionic bias between cations and anions within a range of about 1.5 to 3.0, thereby enabling selective nutrient delivery, controlled ionic conditioning of sap, or selective analyte sampling without disrupting native xylem function.

In one embodiment, the ion-selective membrane 110 is further configured to generate an electrical potential difference in response to changes in ionic activity across the ion-selective membrane 110, enabling passive ionic sensing or compatibility with optional electrical or MEMS-based control elements without requiring continuous active power delivery.

In one embodiment, the ion-selective membrane 110 is mechanically compliant and chemically stable under hydrated conditions, and is configured to maintain permselective performance over prolonged implanted durations without inducing callose deposition, embolism formation, or vascular blockage in adjacent xylem tissue.

In one embodiment, the gas-separating membrane 116 is disposed in fluid communication with the perforated conduit 104, as schematically illustrated. The perforated conduit 104 is configured to permit bidirectional flow of xylem sap, including an inflow region and an outflow region along a longitudinal axis of the tree interfacing device 100.

In operation, dissolved gases present in the liquid flowing through the perforated conduit 104 migrate radially toward the gas-separating membrane 116 under native xylem tension and concentration gradients. The gas-separating membrane 116 is configured to selectively permit passage of gas species while substantially restricting liquid water and dissolved solutes, thereby preventing bulk liquid leakage.

In one embodiment, gas molecules separated from the liquid phase pass through the gas-separating membrane 116 into an adjacent low-pressure or gas-collection region, represented as a vacuum or void space, where the removed gas is isolated from the xylem sap. This configuration inhibits air seeding and embolism formation within the tree vascular system during fluid exchange.

In one embodiment, the gas-separating membrane 116 is arranged circumferentially around the perforated conduit 104, forming a localized degassing section along the conduit length. The degassing section is positioned such that gas removal occurs prior to downstream fluid outflow, thereby ensuring that liquid exiting the tree interfacing device 100 is substantially free of entrained gas.

In one embodiment, the gas-separating membrane 116 cooperates with upstream the ion-selective membrane 110 and the adaptive permeability membrane 112 components of the multi-layer membrane assembly 108 to enable controlled fluid exchange while maintaining embolism suppression under native xylem pressure conditions.

In one embodiment, the multi-layer membrane assembly 108 is configured to regulate fluid transport under native xylem pressure conditions. Exemplary performance ranges include steady-state flow: approximately 0.1-100 μL/s total across the layered membranes of the multi-layer membrane assembly 108, burst operation: up to approximately 100 μL/s for durations of ≤10 minutes, and operating xylem tension: approximately −0.2 MPa to −2 MPa. Flow regulation may occur passively or via stimulus-responsive modulation. The multi-layer membrane assembly 108 generates a proton or ionic gradient of 0.1-2.0 pH units across the multi-layer membrane assembly, thereby enabling selective transport of cations, anions, or neutral solutes through layers.

In some embodiments, the multi-layer membrane assembly 108 includes the cation-selective membrane 110A and the anion-selective membrane 110B arranged axially or radially relative to the perforated conduit 104. These membranes may exhibit effective ion bias factors between approximately 1.5 and 3.0, tunable through fixed charge density and membrane area ratio. Surface zeta potentials may range from approximately −10 mV to −40 mV, enabling electroosmotic contributions to fluid transport under appropriate conditions.

In one non-limiting example, the multi-layer membrane assembly 108 includes the cation-selective membrane 110A comprising sulfonated polymer domains, the anion-selective membrane 110B comprising quaternary ammonium functional groups, the electrode structures 110C formed from PEDOT:PSS films approximately 5 μm thick, an applied pulsed electric field of 1 V/cm synchronized with transpiration minima, resulting in reversible modulation of flow rate by approximately 20-40% without detectable increase in callose deposition or embolism formation.

The adaptive permeability membrane 112 may incorporate stimulus-responsive moieties configured to reversibly alter porosity, permeability, or interfacial pressure. Exemplary stimuli include thermal gating, pH and ionic strength, enzymatic and osmotic effects, electrokinetic and electrorheological options. Thermoresponsive polymers (e.g., LCST-based systems) may be tuned to transition within approximately 20-35° C., such that +1-2° C. temperature shifts result in 10-30% changes in permeability, enabling canopy-linked diurnal modulation. Weak polyelectrolytes (10-40 mol %) may respond to xylem pH variations (approximately pH 5.0-6.5) or ionic strength changes, generating osmotic actuation via fixed charge densities between 0.1 and 1.0 mmol/g. Select crosslinks may be enzymatically labile, allowing slow remodeling in response to endogenous tree enzymes. Osmotic differentials may further bias local micro-pressures.

In one embodiment, the adaptive permeability membrane 112 comprises electrorheological or polarizable microdomains that reorganize under electric, ionic, or osmotic gradients to create transient high-permeability channels analogous to symbiosome microcompartments.

In optional embodiments, conductive traces (e.g., PEDOT:PSS) or ionic liquids (≤1 wt. %) may enable mild electroosmotic flow when an electric field is applied. Alternatively, dispersed electrorheological microdomains (0.1-2 vol %) may form field-tunable permeability pathways.

In one embodiment, the multi-layer membrane assembly 108 may incorporate one or more anti-embolism formulations, including non-ionic surfactants at concentrations of approximately 0.001-0.02% w/v, and/or gas-scavenging additives or microcapsules.

Additionally, the gas-separating membrane 116 may be positioned to permit diffusion of dissolved gases into an adjacent vacuum or low-pressure region, thereby reducing bubble nucleation. In exemplary tests, gas intrusion resistance may be maintained up to approximately 30 kPa, with no visible embolism under sustained xylem tension.

The multi-layer membrane assembly 108 may exhibit stable hydrophilicity, with static water contact angles between approximately 20° and 40°, maintained for at least 30 days under sap-like conditions. Such wetting behavior suppresses gas breakthrough under native sap tensions.

Exemplary quality control metrics may include contact angle and capillary opening pressure measurements, fixed charge density titration and permselectivity testing, micro-CT or SEM analysis of pore and anchor structures, high-speed imaging of dropletization behavior (D32≈10-30 μm), thermal calibration (+0.3° C. uniformity), and pull-out force and leak-before-break testing in wet wood phantoms.

Non-limiting example embodiments include thermal-gated membrane using pectin-grafted PNIPAM with LCST≈30° C. pH-responsive IPN membrane using poly(acrylic acid)-gelatin with fixed charge density≈0.3 mmol/g. Anti-embolism formulation incorporating 0.005% non-ionic surfactant demonstrating zero cavitation under-1.5 MPa equivalent conditions. Field pilot deployments in orchard trees have demonstrated minimal callose formation and stable sap analyte exchange over multi-week periods.

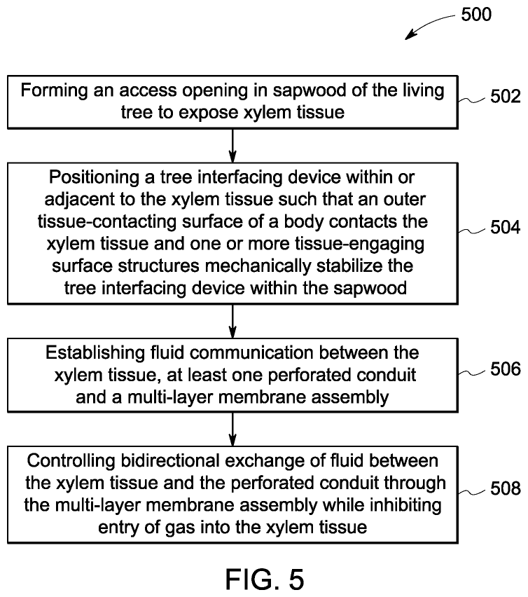

FIG. 5 refers to a flowchart 500 for method of interfacing with xylem tissue of a living tree for controlled exchange of fluids. At step 502, an access opening is formed in sapwood of the living tree to expose xylem tissue. At step 504, the tree interfacing device 100 is positioned within or adjacent to the xylem tissue such that the outer tissue-contacting surface of the body 102 contacts the xylem tissue and the tissue-engaging surface structures 106 mechanically stabilize the tree interfacing device 100 within the sapwood. At step 506, fluid communication is established between the xylem tissue and the perforated conduit 104 through the tissue-engaging surface structures 106 and the multi-layer membrane assembly 108. At step 508, the bidirectional exchange of fluid is controlled between the xylem tissue and the perforated conduit 104 through the multi-layer membrane assembly 108 while inhibiting entry of gas into the xylem tissue. The interfacing is maintained under native xylem pressure conditions without inducing embolism or vascular blockage.

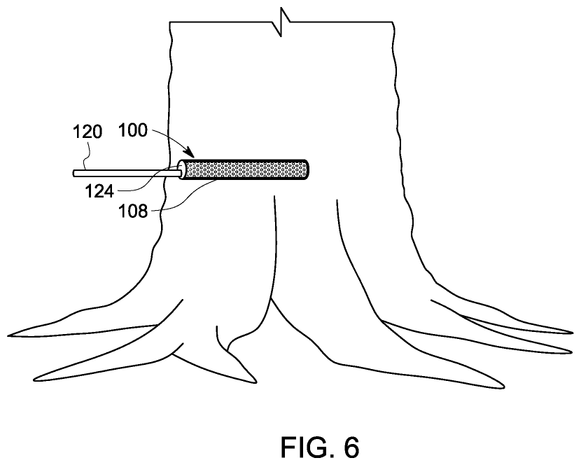

FIG. 6 refers to a schematic perspective view of the tree interfacing device 100 positioned within sapwood of a tree. The tree interfacing device 100 is partially embedded in the sapwood and oriented to place one or more fluid exchange regions in operative communication with xylem tissue, while an outer portion of the tree interfacing device 100 remains accessible for fluid supply or replacement. The multi-layer membrane assembly 108 is configured to reduce hydrodynamic resistance at an interface between the tree interfacing device 100 and native xylem sap by matching at least one fluid property of the delivered fluid to a local sap property. The multi-layer membrane assembly 108 is configured to impart a viscosity or density gradient to the delivered fluid to enable transport through xylem vessels beyond a distribution distance achievable by passive diffusion alone. The multi-layer membrane assembly 108 operates without an external mechanical pump and relies on pressure gradients, osmotic potential, or microfluidic energy conversion within the tree interfacing device 100. The multi-layer membrane assembly 108 adjusts the fluid properties in real time based on the sensed local parameter.

In one embodiment, the multi-layer membrane assembly 108 disposed between the perforated conduit 104 and the surrounding tree tissue, the multi-layer membrane assembly 108 is configured to dynamically regulate fluid transport based on local tree and fluid conditions.

In one embodiment, the tissue-engaging surface structures 106 disposed on an exterior of the body. The tissue-engaging surface structures 106 are configured to mechanically stabilize the tree interfacing device 100 within tree tissue while enabling sustained fluid exchange without triggering vascular isolation or wound occlusion. The tissue-engaging surface structures 106 is configured to sense at least one local parameter comprising sap flow rate, pressure, ionic concentration, or hydraulic resistance. The tissue-engaging surface structures 106 comprises a compliant micro-lattice or microfiber structure configured to integrate with sapwood tissue in a manner analogous to symbiotic fungal hyphae. The compliant micro-lattice enables sustained fluid exchange exceeding 7 days without inducing wound callusing or vascular occlusion.

In one embodiment, the tree interfacing device 100 enables controlled, long-term, bidirectional exchange of sap, nutrients, or treatment fluids with the tree vascular system under native xylem pressure conditions without inducing embolism or vascular blockage.

In one embodiment, the tree interfacing device 100 is configured for insertion into an access opening formed in sapwood xylem tissue of a living tree. In exemplary embodiments, the access opening may be formed by drilling a lateral bore having a diameter of approximately 2 inches to 5 inches, depending on tree species and trunk geometry, such that active xylem tissue is exposed. The tree interfacing device 100 is inserted into the access opening so that the body 102 and associated fluid exchange components are positioned within or immediately adjacent to sapwood xylem. The tree interfacing device 100 is configured to emulate native xylem hydrodynamics by supplying externally introduced fluids in a manner compatible with endogenous xylem transport mechanisms, thereby enabling systemic delivery of nutrients, fertilizers, treatment agents, or diagnostic fluids directly into the tree vascular system.

The body 102 of the tree interfacing device 100 comprises an outer tissue-contacting surface configured to anchor the tree interfacing device 100 within sapwood while maintaining hydraulic continuity with surrounding xylem tissue. In certain embodiments, the body 102 cooperates with an outer anchoring and feedback region forming part of the multi-layer membrane assembly 108, which provides seating, sealing, and controlled fluid exchange at the xylem interface. One or more sensing and receptor elements may be disposed within or adjacent to the outer region of the multi-layer membrane assembly 108, enabling detection of local xylem parameters including pressure, sap flow behaviour, ionic concentration, or hydraulic resistance. These sensed parameters may be used to generate feedback signals indicative of local transport conditions within the tree vascular system.

A middle region of the multi-layer membrane assembly 108 defines the multi-layer membrane assembly 108. The multi-layer membrane assembly 108 is configured to dynamically regulate fluid transport properties in response to feedback derived from the sensing and receptor elements. In operation, the multi-layer membrane assembly 108 adjusts one or more properties of the fluid—including viscosity, density, ionic strength, or interfacial pressure—to promote circumferential and longitudinal displacement of the fluid within surrounding sapwood. This controlled gating action facilitates enhanced radial distribution and systemic transport of the delivered fluid through xylem vessels beyond the immediate vicinity of the outer layer, thereby mimicking pressure-modulated flow behaviour characteristic of native xylem transport.

An inner region of the tree interfacing device 100 comprises the perforated conduit 104, which extends along a longitudinal axis of the body 102 and is configured to receive fluid from an external source via the fluid inlet 120. In certain embodiments, the perforated conduit 104 includes or is coupled to the tissue-engaging surface structures 106 formed as a perforated tube, micro-nozzle mesh, or capillary structure. The tissue-engaging surface structures 106 are configured to radially disperse fluid from the perforated conduit 104 into the multi-layer membrane assembly 108 of the multi-layer membrane assembly 108, from which the fluid is delivered into surrounding xylem tissue. The sealing member 124 may be disposed at the proximal end of the perforated conduit 104 to inhibit leakage and prevent ingress of air or gas during operation. In this manner, nutrient- or fertilizer-infused fluids supplied via the fluid inlet 120 are distributed through the perforated conduit 104, dispersed by the tissue-engaging surface structures 106, and delivered into sapwood xylem under controlled, embolism-resistant conditions.

In operation, fluid delivered through the multi-layer membrane assembly 108 enters active xylem vessels within sapwood tissue. Xylem vessels form continuous hydraulic conduits extending longitudinally through the trunk and branches of the tree. Transpiration-driven tension generated by leaf stomatal evaporation produces upward bulk flow of sap within these vessels. Once introduced into the xylem stream, the delivered fluid is transported through the vascular network by this transpiration-driven flow and distributed throughout branches and canopy tissues of the tree. The multi-layer membrane assembly 108 is configured to introduce the fluid at physiologically compatible pressure and viscosity conditions such that the introduced fluid integrates with native sap flow without inducing embolism or vascular blockage.

The tree interfacing device 100 provides technical advantages over conventional tree injection systems by combining a compliant anchoring structure, embolism-suppressing gas separation, and selective ionic membrane transport within a single multi-layer architecture. This configuration enables sustained vascular interfacing under native xylem tension conditions while minimizing tissue damage, gas intrusion, and uncontrolled leakage.

In an exemplary embodiment, table 1 exemplary base membrane matrices for the multi-layer membrane assembly 108.

TABLE 1

| | | Functional Role in the tree |
|---|---|---|
| Material System | Representative Properties | interfacing device 100 |
| Pectin-grafted poly(N- | Thermoresponsive polymer | Enables temperature- |
| isopropylacrylamide) | exhibiting a lower critical | responsive modulation of |
| (Pectin-g-PNIPAM) | solution temperature (LCST) | membrane permeability |
| | in a range of approximately | correlated with diurnal |
| | 28-32° C., presence of | canopy temperature |
| | galacturonic acid motifs | variation, provides chemical |
| | | similarity to native pectin |
| | | components of tree cell |
| | | walls |
| Alginate-Cellulose | Ionically crosslinked hydrogel | Provides mechanical |
| Nanofiber (CNF) | matrix, tunable elastic | compliance matched to |
| Composite Hydrogels | modulus via divalent cation | sapwood tissue, enhances |
| | concentration, fibrous | anchoring stability, divalent |
| | reinforcement | ion crosslinks emulate |
| | | native tree cell wall |
| | | interactions |
| Zwitterionic Polymeric | Electrically neutral net charge, | Reduces biofouling and |
| Hydrogels (e.g., poly | high hydration capacity, | dampens damage-associated |
| (sulfobetaine | reduced nonspecific | molecular pattern (DAMP) |
| methacrylate)) | adsorption | signaling, maintains stable |
| | | interfacial wetting over |
| | | extended implanted |
| | | durations |
| Poly (acrylic acid)- | Weak polyelectrolyte | Permits permeability |
| Gelatin Interpenetrating | behavior, pH-responsive | adjustment in response to |
| Networks (IPNs) | swelling, hydrogen bonding | sap pH and osmotic |
| | capability | variations, facilitates |
| | | adhesion to cellulose-rich |
| | | tissues |
| Chitosan-Based | Cationic polymer backbone, | Provides resistance to |
| Hydrogel Systems | inherent antimicrobial | microbial colonization, |
| | activity, ionically interactive | enables ion-mediated gating |
| | | and electrostatic interaction |
| | | with anionic tree cell wall |
| | | components |

In some embodiments, the multi-layer membrane assembly 108 comprises one or more hydrogel matrices selected from the exemplary material systems listed in Table 1, wherein the selection and combination of such matrices are configured to provide mechanical compliance, controlled permeability, and biochemical compatibility with xylem tissue.

TABLE 2

| | | Functional Contribution within the |
|---|---|---|
| | | multi-layer membrane assembly |
| Additive Class | Representative Examples | 108 |
| Electroresponsive | Conductive polymers such | Enable electroosmotic flow |
| Fillers | as PEDOT: PSS, | assistance, electrorheological |
| | polypyrrole nanoparticles, | modulation of permeability, or field- |
| | carbon-based conductive | responsive tuning of ionic transport |
| | domains | under applied electric fields |
| Enzyme-Labile | Pectinase-cleavable | Permit gradual structural remodeling |
| Crosslinking | linkers, cellulase-sensitive | of the membrane in response to |
| Moieties | bonds, polysaccharide- | endogenous tree enzymes or |
| | based degradable junctions | environmental conditions, enabling |
| | | time-dependent permeability |
| | | adjustment or triggered release |
| Osmotically Active | Fixed-charge sulfonate | Generate localized osmotic pressure |
| Groups | groups, carboxylate- | gradients that bias passive fluid |
| | containing polymer | transport and contribute to pressure- |
| | segments, weak | responsive gating behavior |
| | polyelectrolyte domains | |
| Thermal Phase- | Paraffin or fatty-acid | Store and release thermal energy to |
| Change Inclusions | microcapsules, polymer- | locally bias temperature-responsive |
| | encapsulated latent-heat | permeability transitions, including |
| | materials | LCST-based gating mechanisms |
| Anti-Embolism | Non-ionic surfactants such | Suppress gas nucleation and bubble |
| Surfactant | as polysorbate 20, tree- | growth under xylem tension, thereby |
| Additives | compatible | reducing embolism risk during fluid |
| | fluorosurfactants at low | exchange |
| | concentration | |

In some embodiments, one or more functional additives listed in Table 2 are incorporated within the adaptive permeability membrane 112, the gel-based compliant matrix 114, or combinations thereof, wherein the type and concentration of such additives are selected to provide passive, stimulus-responsive, or electrically assisted modulation of fluid transport without inducing vascular blockage or tissue damage.

TABLE 3

| Structural | Representative | Functional Role within the tree |
|---|---|---|
| Component | Implementation | interfacing device 100 |
| Micro-Anchor | Elastomeric or polymeric | Provide mechanical stabilization |
| Fins | skeletal features formed by soft | by lodging within intercellular |
| | lithography, micromolding, or | spaces and middle lamella regions |
| | laser patterning and over-coated | while displacing, rather than |
| | with hydrogel | fracturing, xylem cell walls |
| Expandable | Swellable polymer elements, | Generate self-sealing contact |
| Collars or Rings | including superabsorbent | within a lateral bore following |
| | polyacrylate or hydrogel rings, | insertion by controlled radial |
| | positioned circumferentially | expansion, enhancing leak |
| | around the body | resistance without excessive |
| | | compressive stress |
| Porous Bead | Silica, agarose, or crosslinked | Introduce tortuous fluid pathways |
| Inclusions | dextran beads embedded within | to modulate permeability, assist |
| | the gel-based compliant matrix | gas suppression, and provide |
| | | structural heterogeneity within the |
| | | multi-layer membrane assembly |
| | | 108 |
| Nanofiber | Electrospun cellulose acetate, | Increase mechanical integrity and |
| Reinforcement | cellulose nanofibers, silk fibroin, | tear resistance while preserving |
| | or similar fibrous networks | overall compliance and modulus |
| | dispersed within hydrogel | matching to sapwood tissue |
| Hollow or | Polymer-shelled microcapsules | Enable localized release of |
| Functional | configured to contain gas- | functional agents, contribute to |
| Microcapsules | scavenging agents, surfactants, | embolism prevention, or provide |
| | nutrients, or treatment fluids | active delivery functionality |
| | | within the multi-layer membrane |
| | | assembly 108 |

In some embodiments, one or more structural enhancers listed in Table 3 are incorporated into the multi-layer membrane assembly 108, the body 102, or the tissue-engaging surface structures 106, either individually or in combination, to improve mechanical anchoring, sealing performance, and functional durability of the tree interfacing device 100 during prolonged implanted in sapwood tissue.

TABLE 4

| | Representative | | | | Representative |
|---|---|---|---|---|---|
| Layer | Thickness/ | | Representative | Primary | Performance |
| Description | Dimension | | Composition | Function | Characteristics |
| Tissue- | ~0.1-1 | μm | Zwitterionic | Provides low- | Contact |
| contact bio | | | polymeric | DAMP tissue | angle ~20-40°, |
| integration | | | copolymer with | interfacing, | swollen |
| skin (part of | | | pectin-mimetic | wetting | modulus ~50- |
| body 102/ | | | grafts | control, and | 300 kPa |
| multi-layer | | | | anti-fouling at | |
| membrane | | | | xylem contact | |
| assembly | | | | surface | |
| 108) | | | | | |
| Cation- | ~0.2-1 | μm | Sulfonated | Regulates | Na⁺/Cl⁻ |
| selective | | | polysulfone, | selective cation | permselectivity ~1.5- |
| membrane | | | sulfonated | transport and | 3.0, OCP |
| 110A | | | polyamide, or | supports | shift ±10-60 |
| | | | equivalent | Donnan- | mV |
| | | | cation- | potential-based | |
| | | | exchange | sensing | |
| | | | polymer | | |
| Anion- | ~0.2-1 | μm | Quaternized | Selective anion | Anion/cation |
| selective | | | poly (arylene | transport and | bias (e.g., |
| membrane | | | ether), | counter-ion | NO₃⁻/Na⁺), |
| 110B | | | quaternized | exclusion | OCP shift ±10- |
| | | | polyamine, or | | 60 mV |
| | | | equivalent | | |
| Gas- | ~200-800 | μm | Hydrophilic | Inhibits gas | No air passage |
| separating | | | silica or | entry, | up to ~30 kPa, |
| membrane | | | BaSO₄-loaded | suppresses | radiopacity |
| 116 | | | hydrogel beads | embolism, and | suitable for |
| implemented | | | dispersed in | provides | microCT |
| as bead- | | | alginate-CNF | tortuous flow | |
| containing | | | matrix, non- | paths | |
| region | | | ionic surfactant | | |
| | | | 0.001-0.02% | | |
| | | | w/v | | |
| Adaptive | ~100-400 | μm | CNF-reinforced | Passive | Opening |
| permeability | | | hydrogel or | pressure- | threshold ~10- |
| membrane | | | acrylate | threshold | 30 kPa, pore |
| 112 | | | polymer with | regulation of | throat ~2-5 μm |
| (pressure- | | | tapered/conical | fluid exchange | |
| responsive | | | pores and | | |
| region) | | | hydrophilic | | |
| | | | surface | | |
| Tissue- | ~100-300 | μm | Microporous | Enables radial | Droplet |
| engaging | | | polyethylene | fluid | D32 ~10-30 μm |
| surface | | | sheet or | communication | with ~5-25 μm |
| structures | | | sintered glass | and controlled | orifices |
| 106 | | | microfiber, | dispersion into | |
| configured | | | plasma-treated | surrounding | |
| as micro- | | | | xylem | |
| nozzle mesh | | | | | |

| | | | | |
|---|---|---|---|---|
| Adaptive | Functional | Printed carbon | Enables | Power ~1-5 |
| permeability | traces ~20-80 | or NiCr heater | temperature- | mW/cm² |
| membrane | μm | traces with | responsive | for +1-2° C., |
| 112 | | NTC thermistor | permeability | sensing |
| including | | on flexible | modulation | resolution ~0.1° C. |
| thermal- | | substrate | and sensing | |
| responsive | | | | |
| region | | | | |
| Body 102 | Wall ~0.5-1.5 | CNF-reinforced | Provides | Seal pressure ≥10 |
| with the | mm, fins ~50- | hydrogel over | structural | kPa, pull- |
| tissue- | 300 μm | compliant TPU | integrity, self- | out force ~0.5- |
| engaging | | or silicone | affixing | 2N |
| surface | | skeleton | anchoring, and | |
| structures | | | sealing within | |
| 106 | | | sapwood | |

In exemplary embodiments, the multi-layer membrane assembly 108 of the tree interfacing device 100 comprises an outer-to-inner stack including the ion-selective membrane 110, the adaptive permeability membrane 112, the gas-separating membrane 116, and the tissue-engaging surface structures 106 formed on the body 102, as summarized in Table 4.

In certain embodiments, the multi-layer membrane assembly 108 includes a tissue-contact bio-integration skin defining an outermost layer disposed at the interface between the tree interfacing device 100 and xylem tissue. The bio-integration skin is configured to provide low-damage adhesion, hydration shell maintenance, and controlled wetting at the xylem interface, thereby suppressing damage-associated molecular pattern (DAMP) signaling.

In exemplary embodiments, the bio-integration skin comprises a zwitterionic sulfobetaine-based polymeric layer having a thickness of approximately 50 nm to 200 nm disposed over pectin-mimetic grafted structures enriched in galacturonic acid moieties formed on a porous primer region. The combined thickness of the bio-integration skin is approximately 0.1 μm to 1 μm. The bio-integration skin exhibits a static water contact angle of approximately 20° to 40° and a swollen elastic modulus within a range of approximately 50 kPa to 300 kPa, thereby mechanically matching adjacent sapwood tissue.

In use, the bio-integration skin promotes stable hydraulic flux across the membrane assembly 108 while exhibiting reduced callose deposition and lignification relative to untreated control interfaces during implanted periods of at least 7 to 14 days.

In certain embodiments, the multi-layer membrane assembly 108 further comprises ion-selective skins arranged as the cation-selective membrane 110A, and the anion-selective membrane 110B, configured to enable selective ionic transport, local ionic activity sensing, and, in optional implementations, electro-osmotic steering of fluid flux when coupled to a control module.

The cation-selective membrane 110A comprises a cation-exchange membrane (CEM) disposed inward of the tissue-contact bio-integration skin. The cation-exchange membrane includes a dense ion-selective polymeric skin formed from a sulfonated polysulfone material or a sulfonated polyamide material, the polymer matrix incorporating fixed anionic functional groups at a charge density in a range of approximately 0.5 to 1.5 mmol/g. The cation-exchange membrane has a thickness in a range of approximately 0.2 μm to 1 μm, and may be supported on a porous sublayer to maintain mechanical integrity while preserving ionic selectivity.

The anion-selective membrane 110B comprises an anion-exchange membrane (AEM) positioned adjacent to the cation-exchange membrane. The anion-exchange membrane includes a polymeric film formed from a quaternized poly (arylene ether) material or a polyethyleneimine (PEI)-crosslinked polymer network, the film incorporating fixed cationic functional groups at a charge density in a range of approximately 0.8 to 2.0 mmol/g. The anion-exchange membrane similarly has a thickness in a range of approximately 0.2 μm to 1 μm.

In operation, the combined cation-exchange and anion-exchange skins provide ionic permselectivity, enabling preferential transport of target ions across the multi-layer membrane assembly 108. In representative implementations, the ion-selective skins exhibit Na⁺/Cl⁻ or K⁺/Cl⁻ permselectivity ratios in a range of approximately 1.5 to 3.0. Additionally, the ion-selective skins are configured to generate a measurable open-circuit potential (OCP) across the multi-layer membrane assembly 108, wherein a change in local ionic activity of one logarithmic unit produces a corresponding potential shift in a range of approximately #10 mV to +60 mV, thereby enabling in situ ionic sensing.

In optional embodiments, the electrode structures 110C (described elsewhere in the specification) may be positioned adjacent to or in electrical communication with one or both of the ion-selective skins to enable electro-osmotic modulation of fluid flow. When an external bias voltage in a range of approximately 0 to 1.5 V is applied, the ion-selective skins support controlled electro-osmotic flow, producing a flux modulation of approximately ±10% to ±50% relative to passive operation, while maintaining electrical currents within microampere to milliampere limits suitable for low-power, tree-safe operation.

In certain embodiments, the multi-layer membrane assembly 108 includes an anti-embolism bead bed defining a gas-separating region forming at least a portion of the gas-separating membrane 116. The bead bed is configured to suppress ingress of air or gas into the xylem while maintaining hydraulic continuity and providing radiopaque landmarks for imaging-based verification of device placement.

In exemplary embodiments, the bead bed comprises hydrogel beads having diameters in a range of approximately 10 μm to 100 μm, including silica beads or barium sulfate-loaded beads, dispersed at a volume fraction of approximately 25% to 45% within an alginate-cellulose nanofiber (CNF) gel matrix. The bead bed defines a packed layer having a thickness of approximately 200 μm to 800 μm and a porosity in a range of approximately 0.35 to 0.55.

The bead bed may further incorporate a slow-release non-ionic surfactant at a concentration of approximately 0.001% to 0.02% (w/v), configured to suppress gas nucleation and bubble growth under native xylem tension. In operation, the bead bed exhibits no visible air passage under pressure differentials of up to approximately 30 kPa and provides sufficient radiographic contrast to enable visualization using micro-computed tomography (microCT). The bead bed may further contribute to gentle micro-anchoring of the multi-layer membrane assembly 108 within sapwood tissue through mechanical interlocking of hydrated beads with surrounding intercellular spaces.

In certain embodiments, the tissue-engaging surface structures 106 are configured to provide passive pressure-responsive flow regulation corresponding to natural variations in xylem sap tension. The tissue-engaging surface structures 106 are positioned inward of the anti-embolism bead bed and comprises a pressure-thresholding porous matrix formed from a cellulose nanofiber (CNF)-reinforced hydrogel or, in alternative embodiments, a UV-curable acrylate polymer. The material of tissue-engaging surface structures 106 includes a hydrophilic surface chemistry, optionally incorporating polyethylene glycol (PEG) or PEG-like moieties, to promote stable wetting and suppress gas nucleation under negative pressure conditions.

The tissue-engaging surface structures 106 has an overall thickness in a range of approximately 100 μm to 400 μm and defines a plurality of conically shaped pores extending through the thickness of the layer. Each pore includes an inlet region having an effective diameter in a range of approximately 10 μm to 20 μm, a constricted throat region having an effective diameter in a range of approximately 2 μm to 5 μm, and a tapered transition between the inlet and throat regions defined by a taper angle in a range of approximately 5 degrees to 15 degrees.

In operation, the conical pore geometry cooperates with the hydrophilic surface chemistry to establish a capillary pressure threshold, such that fluid flow through the tissue-engaging surface structures 106 initiates only when the local pressure differential exceeds a predetermined opening pressure. In representative embodiments, the tapered-pore pressure layer exhibits an opening threshold in a range of approximately 10 kPa to 30 kPa, corresponding to physiological sap tension fluctuations, and further exhibits a closing hysteresis of 20% or less, thereby reducing oscillatory opening and closing during transient pressure changes.

When integrated within the layered membranes of the multi-layer membrane assembly 108, the tissue-engaging surface structures 106 support a total volumetric flow rate in a range of approximately 0.1 μL/s to 100 μL/s under normal operating pressures, thereby providing fine passive regulation of fluid exchange without the need for external power, active valves, or mechanical actuators. The tissue-engaging surface structures 106 thus functions as a self-regulating hydraulic gate, protecting downstream layers from pressure spikes while maintaining continuous sap-compatible transport.

In certain embodiments, the multi-layer membrane assembly 108 includes an atomizer micro-nozzle mesh defining a dispersive fluid delivery layer, which may form part of or be integrated with the tissue-engaging surface structures 106. The atomizer layer is configured to break a substantially continuous fluid stream into dispersible micro-droplets to enhance lateral infiltration of delivered fluids into xylem rays and across pit fields.

In exemplary embodiments, the atomizer layer comprises a microporous polyethylene (PE) disc or a sintered glass microfiber element that has been plasma-treated to enhance surface hydrophilicity. The atomizer layer has a thickness of approximately 100 μm to 300 μm and a porosity in a range of approximately 30% to 50%. The atomizer layer defines a plurality of micro-orifices having diameters in a range of approximately 5 μm to 25 μm, optionally including a tapered or chamfered inlet geometry to promote controlled droplet formation.

In operation, the atomizer layer produces droplets having a Sauter mean diameter (D32) of approximately 10 μm to 30 μm in sap-like fluids and increases radial distribution of delivered fluid into surrounding sapwood tissue by at least approximately 1.5× relative to non-atomized delivery at equivalent flux conditions.

In certain embodiments, the adaptive permeability membrane 112 is configured to provide localized temperature modulation and real-time temperature sensing. The adaptive permeability membrane 112 enables controlled biasing of local membrane temperature to regulate stimulus-responsive permeability without materially altering mechanical compliance of the multi-layer membrane assembly 108.

In exemplary embodiments, the adaptive permeability membrane 112 comprises printed resistive heater traces formed from carbon-based conductors or nickel-chromium (NiCr) alloys, having a sheet resistance in a range of approximately 20/sq to 80 Ω/sq, and temperature-sensing traces comprising negative temperature coefficient (NTC) thermistors having a nominal resistance of approximately 100 kΩ. The heater and sensor traces are patterned on a thin, flexible polymeric substrate, such as polyimide, and define functional trace thicknesses in a range of approximately 20 μm to 80 μm. The traces may be recessed or embedded within adjacent membrane layers to avoid localized stiffening.

In operation, the adaptive permeability membrane 112 provides heating power in a range of approximately 1 mW/cm² to 5 mW/cm², sufficient to raise local membrane temperature by approximately 1° C. to 2° C. within about 60 s to 180 s. Temperature sensing resolution of approximately 0.1° C. may be achieved, with drift of less than approximately 0.05° C. per day, thereby enabling stable, closed-loop thermal regulation of membrane permeability during implanted.

In certain embodiments, the tree interfacing device 100 includes a structural core defining an outer support layer that provides mechanical sealing, self-affixing anchoring, and load transfer to surrounding sapwood tissue without inducing continuous cell wall fracture. The structural core forms part of the body 102 and supports the multi-layer membrane assembly 108.

In exemplary embodiments, the structural core comprises a cellulose nanofiber (CNF)-reinforced hydrogel disposed over a compliant polymeric skeleton formed from thermoplastic polyurethane (TPU) or silicone. The hydrogel exhibits a swollen elastic modulus in a range of approximately 100 kPa to 500 kPa, selected to mechanically match sapwood tissue. The structural core has an outer diameter matched to a lateral bore formed in sapwood, typically in a range of approximately 2 mm to 6 mm, a wall thickness of approximately 0.5 mm to 1.5 mm, and a longitudinal length of approximately 5 mm to 20 mm.

The structural core includes the tissue-engaging surface structures 106 in the form of micro-fins extending radially from the body 102. The tissue-engaging surface structures 106 have lengths in a range of approximately 50 μm to 300 μm, tip radii of approximately 5 μm to 30 μm, rake angles of approximately 10° to 30°, and spacings of approximately 100 μm to 400 μm. The micro-fins are configured to displace and interlock with intercellular spaces and middle lamella regions of sapwood tissue rather than cutting cell walls.

In operation, the structural core generates circumferential sealing pressures of at least approximately 10 kPa following hydration-induced swelling while maintaining hydraulic continuity. Pull-out forces in a range of approximately 0.5 N to 2 N may be achieved in wet wood phantom testing. Imaging-based assessment, including micro-computed tomography, confirms the absence of continuous cell wall fracture planes adjacent to the tree interfacing device 100.

In some embodiments, the gel-based compliant matrix 114 and/or the adaptive permeability membrane 112 further comprises dispersed responsive nanogels embedded within a continuous hydrogel network. The nanogels may comprise copolymers of poly(N-isopropylacrylamide) and acrylic acid, configured to respond to both temperature and pH variations present in xylem sap.

Such nanogels may reversibly swell or collapse in response to combined thermal and ionic stimuli, thereby providing localized, multi-parameter modulation of permeability without requiring bulk deformation of the multi-layer membrane assembly 108.

In some embodiments, the multi-layer membrane assembly 108 comprises magnetically responsive microbeads embedded within the gel-based compliant matrix 114 or gas-separating membrane 116. The microbeads may comprise iron oxide particles encapsulated within alginate or hydrogel matrices.

When subjected to an external or localized magnetic field, such microbeads may alter local packing density, pore geometry, or tortuosity within the multi-layer membrane assembly 108, enabling field-tunable permeability or mechanical stiffening without direct contact between magnetic components and tree tissue.

In some embodiments, the multi-layer membrane assembly 108 includes enzyme-loaded hydrogel beads configured for slow release of tree-compatible enzymes, including pectinase or cellulase, over extended time periods.

The controlled release of such enzymes may enable gradual remodeling of local porosity within the multi-layer membrane assembly 108 or adjacent xylem tissue, thereby facilitating long-term permeability stabilization without acute degradation of cell walls or induction of tree defense responses.

In some embodiments, the multi-layer membrane assembly 108 further comprises ion-exchange beads embedded within the gel-based compliant matrix 114. The beads may comprise sulfonated polystyrene, carboxylated polymers, or equivalent ion-exchange materials.

Such beads may locally modify ionic strength, osmotic pressure, or ion availability within the multi-layer membrane assembly 108, thereby biasing passive fluid transport and enhancing the effectiveness of the ion-selective membrane 110.

In some embodiments, the multi-layer membrane assembly 108 is configured with a radially graded porosity, wherein regions closer to the tissue-contacting surface comprise relatively larger pores to reduce hydraulic resistance, and regions closer to the perforated conduit 104 comprise smaller pores to enable fine flow regulation and embolism suppression.

In exemplary embodiments, biocompatibility of embedded gel and bead systems is evaluated by monitoring callose deposition, lignification, and tyloses formation in xylem tissue adjacent to the implanted device over time, confirming minimal activation of damage-associated molecular pattern (DAMP) pathways.

In one embodiment, the tree interfacing device 100 and associated membrane assembly 108 provide multiple technical advantages over conventional tree injection, sap sampling, and vascular interfacing approaches. The tree interfacing device 100 enables precise, bidirectional fluid exchange with xylem tissue at physiologically compatible flow rates (e.g., 0.1-100 μL/s) under native xylem tensions. By mechanically matching the compliance of sapwood tissue and avoiding rigid probes or open conduits, the tree interfacing device 100 minimizes vessel rupture, pit membrane damage, and uncontrolled leakage.

The incorporation of the gas-separating membrane 116, tapered pore geometries, hydrophilic surfaces, and optional anti-embolism additives significantly reduces the risk of air seeding and cavitation. This allows sustained operation under negative xylem pressures without inducing embolism, a major limitation of existing sap access techniques.

Biomimetic surface chemistries, zwitterionic coatings, pectin-mimetic grafts, and the tissue-engaging surface structures 106 reduce activation of damage-associated molecular pattern (DAMP) pathways. As a result, the tree interfacing device 100 exhibits low callose deposition, minimal lignification, and reduced tyloses formation, enabling longer implanted durations compared to conventional injection needles or rigid ports.

The tissue-engaging surface structures 106, including compliant micro-fins and swelling-assisted anchoring, allow the tree interfacing device 100 to self-stabilize within intercellular spaces and middle lamella regions without cutting cell walls. This improves positional stability, seal integrity, and micromotion tolerance while avoiding chronic tissue injury. The tissue-engaging surface structures 106, including compliant micro-fins and swelling-assisted anchoring, allow the tree interfacing device 100 to self-stabilize within intercellular spaces and middle lamella regions without cutting cell walls. This improves positional stability, seal integrity, and micromotion tolerance while avoiding chronic tissue injury.

The inclusion of the ion-selective membrane 110 provides selective ionic transport, local ionic activity sensing, and electro-osmotic biasing. This enables selective delivery or sampling of nutrients, ions, or analytes and supports integrated sensing of sap chemistry directly at the xylem interface. The inclusion of the ion-selective membrane 110 provides selective ionic transport, local ionic activity sensing, and electro-osmotic biasing. This enables selective delivery or sampling of nutrients, ions, or analytes and supports integrated sensing of sap chemistry directly at the xylem interface. By combining mechanical compliance, embolism suppression, low-fouling surfaces, and graded porosity, the invention supports long-term implanted exceeding 24 hours, and potentially multi-day or multi-week operation, without vascular blockage or significant loss of function.

The tree interfacing device 100 is adaptable for use in trees, woody trees, and agricultural crops, and supports diverse applications including nutrient delivery, biostimulant administration, tracer introduction, and micro-sampling of xylem sap for diagnostics or research. The layered membrane architecture allows individual functional layers to be tuned, substituted, or combined without altering the overall device concept. This modularity supports scalable manufacturing, customization for different tree species, and integration with optional sensing or actuation components.

In some embodiments, the tree interfacing device 100 is configured as a hydrodynamic-mimetic gating system that emulates native sapwood fluid transport behavior. The tree interfacing device 100 comprises the membrane sleeve forming part of the multi-layer membrane assembly 108, positioned to directly contact xylem parenchyma tissue, while control elements are confined within a supporting housing forming part of the body 102. In this configuration, only compliant, biomimetic membrane materials of the multi-layer membrane assembly 108 interface with tree tissue, thereby reducing activation of damage-associated molecular pattern (DAMP) signaling and promoting compatibility with symplastic transport pathways within sapwood.

In exemplary embodiments, the multi-layer membrane assembly 108 functions as a synthetic root-like interface that regulates radial fluid exchange between xylem vessels and surrounding parenchyma by modulating local hydrodynamic, ionic, and microfluidic conditions. Controlled exchange may be provided as steady-state flow or as intermittent burst operation through the perforated conduit 104, synchronized with native sap flow conditions.

In some embodiments, anchoring of the membrane sleeve within sapwood tissue is inspired by natural root-microorganism symbioses, including arbuscular mycorrhizae, Hartig net structures, and symbiosomal membrane interfaces. Analogous to these biological systems, the disclosed tree interfacing device 100 employs compliant hydrogel matrices, electrospun membranes, or hybrid polymer-nanofiber lattices forming part of the multi-layer membrane assembly 108, which interweave with intercellular spaces of xylem parenchyma without fracturing cell walls or inducing wound responses.

Such anchoring structures may comprise the tissue-engaging surface structures 106, including micro-anchor fins, expandable polymer regions, or lattice-like hydrogel architectures configured to lodge within pit fields or middle lamella regions of sapwood tissue, thereby enabling stable mechanical fixation while maintaining physiological compatibility with tree vascular tissues.

In some embodiments, the multi-layer membrane assembly 108 is configured to modulate delivered fluid properties in coordination with native sapwood hydrodynamics to enhance circumferential and axial distribution. Parameters including fluid temperature, ionic concentration, particle size distribution, and viscosity may be selectively adjusted relative to measured sap flow parameters obtained via optional sensing elements disposed within or adjacent to the multi-layer membrane assembly 108 or the perforated conduit 104, thereby promoting self-directed dispersion of delivered fluids into surrounding sapwood tissue.

Without being bound by theory, such modulation may generate chemo-taxic or microfluidic driving forces that bias radial displacement of delivered solutions within a few millimeters of the membrane-tissue interface defined by the body 102, after which native tree hydraulic systems distribute the fluid throughout the canopy.

In preferred embodiments, only the multi-layer membrane assembly 108, the tissue-engaging surface structures 106, and associated compliant surface chemistries are placed in direct contact with xylem tissue, while electronic components, MEMS-based sensing elements, power components, and control circuitry are isolated within the body 102 of the tree interfacing device 100. This physical separation minimizes electrochemical interaction with tree tissue and further suppresses DAMP-related signaling responses.

In certain applications, the tree interfacing device 100 functions as a synthetic root module implanted within a trunk or branch, enabling precision nutrient delivery consistent with four-R nutrient management principles, including right source, right rate, right timing, and right placement. Such applications are particularly advantageous for mature trees or woody trees where root-based nutrient intervention is impractical.

In certain embodiments, the tree interfacing device 100 operates within a defined system-level performance envelope. Total steady-state fluid exchange across the multi-layer membrane assembly 108 occurs within a flow band of approximately 0.1 μL/s to 100 μL/s, with transient burst operation at approximately 100 μL/s for durations not exceeding about 10 minutes. Passive pressure regulation is provided by tapered pore geometries associated with the tissue-engaging surface structures 106, exhibiting opening thresholds of approximately 10 kPa to 30 kPa, while anti-embolism integrity of the gas-separating membrane 116 is maintained under pressure differentials up to approximately 30 kPa.

The ion-selective membrane 110 provides effective cation-to-anion or anion-to-cation bias factors in a range of approximately 1.5 to 3.0, tunable through membrane area ratios and fixed charge density. Dropletization provided by the tissue-engaging surface structures 106 yields a Sauter mean droplet diameter (D32) of approximately 10 μm to 30 μm and increases radial spread of delivered fluids into surrounding sapwood tissue by at least approximately 1.5× relative to non-atomized delivery at equivalent pressure differentials.

Thermal modulation provided by the adaptive permeability membrane 112 and associated thermal trim elements enables local temperature adjustments of approximately +1° C. to +2° C., resulting in permeability window shifts of approximately 10% to 30% for thermoresponsive or pH-responsive membrane components. The tissue-contacting surfaces maintain stable hydrophilicity characterized by static water contact angles of approximately 20° to 40° for implanted durations of at least approximately 30 days, without gas breakthrough under native xylem tensions.

In certain embodiments, quality control verification of the tree interfacing device 100 includes evaluation of wetting behavior and capillary performance by contact angle measurement and capillary opening pressure analysis, verification of pore geometry by microscopic inspection or replica casting, and assessment of ionic performance by fixed charge density titration, permselectivity testing, and open-circuit potential measurements. Anti-embolism performance is verified by gas intrusion testing under pressure differentials up to approximately 30 kPa and by micro-computed tomography imaging of bead distribution and void formation. Mechanical performance is verified by pull-out force testing and leak-before-break seal integrity testing under hydrated conditions representative of sapwood tissue.

The tree interfacing device 100 provides nutrient delivery is rendered substantially independent of soil chemistry, such that the module provides bioavailable nutrients directly to sapwood regardless of soil pH, cation-exchange capacity, salinity, organic matter content, or other soil-dependent factors that limit nutrient uptake, including conditions in which soil analysis indicates surplus nutrient levels but plant intake remains restricted.

In one embodiment, the tree interfacing device 100 comprises the multi-layer membrane assembly 108 that supports a plurality of agriculturally relevant substances, including but not limited to inorganic nutrients, micronutrients, growth regulators, phytohormones, or other chemical agents delivered to or extracted from sapwood tissue.

In certain embodiments, the multi-layer membrane assembly 108 is configured to enable controlled ionic and molecular transport through a plurality of functional membrane layers arranged between the perforated conduit 104 and surrounding sapwood tissue. In operation, ions or nutrient species introduced through the fluid inlet 120 pass through the ion-selective membrane 110 and subsequently traverse the adaptive permeability membrane 112 and associated hydrogel matrix layers before entering the xylem sap stream.

Within the multi-layer membrane assembly 108, transport may be influenced by electro-osmotic forces, osmotic pressure gradients, and stimulus-responsive permeability modulation. For example, when the delivered fluid contains an ionic species such as nitrate (NO₃⁻), the ion-selective membrane 110 may exchange counter-ions within the biocompatible polymeric matrix, releasing the transported ion into downstream membrane regions. The released ions subsequently migrate through the multi-layer membrane assembly 108 under combined electrostatic, osmotic, and microfluidic transport forces before entering the sapwood vascular stream.

In some embodiments, one or more layers of the multi-layer membrane assembly 108 include electro responsive materials configured to enhance directional ionic transport. Such layers may include conductive polymers or electrically responsive domains dispersed within a polymer matrix. Representative materials include poly(3,4-ethylenedioxythiophene)-polystyrene sulfonate (PEDOT:PSS), polypyrrole nanoparticles, graphene domains, or other conductive polymer composites.

When a low-voltage electric field is applied across the multi-layer membrane assembly 108, typically in the range of about 0.1 V to about 0.3 V, polarization of the conductive domains produces localized electric field gradients within the gel-based compliant matrix 114. These gradients promote electro-osmotic flow and directional ionic migration toward the sapwood interface. As a result, transported ions experience a directional bias that improves delivery efficiency into the tree vascular system without increasing hydraulic pressure within the xylem.

In certain embodiments, the multi-layer membrane assembly 108 further comprises an osmotically active polymer layer containing fixed ionic groups configured to generate localized osmotic pressure gradients. Such groups may include sulfonate (—SO₃⁻) functional groups, carboxylate (—COO⁻) moieties, or other weak polyelectrolyte segments incorporated within the polymer backbone.

These fixed charge groups create Donnan exclusion zones within the ion-selective membrane 110, selectively influencing the migration of ionic species. In particular, multivalent cations such as potassium or calcium may be partially retained within the gel-based compliant matrix 114 while anionic nutrient species are preferentially transported toward the sapwood interface. Hydration shells surrounding the polyelectrolyte network generate localized osmotic forces that contribute to fluid displacement through the multi-layer membrane assembly 108.

As used herein, the term “the gel-based compliant matrix 114” refers to a continuous polymeric or hydrogel network forming the structural backbone of the multi-layer membrane assembly, within which pores, ion-exchange groups, conductive additives, and other functional inclusions are distributed. The gel-based compliant matrix 114 provides mechanical support, defines pore geometry, and regulates permeability and ionic transport across the multi-layer membrane assembly 108.

In some embodiments, the multi-layer membrane assembly 108 comprises a crosslinked polymer network containing enzyme-labile linkages that respond to endogenous enzymes present in tree tissues. For example, crosslinking structures may include pectinase-cleavable linkers, cellulase-sensitive bonds, or other polysaccharide-derived junctions.

Over time, enzymatic interaction with these linkages gradually increases the effective pore size of the membrane network. In representative embodiments, pore diameters may increase from approximately 2 nm to approximately 5-10 nm over periods ranging from hours to several days following implantation. This gradual structural relaxation enables adaptive adjustment of permeability and allows controlled increases in nutrient flux while maintaining compatibility with surrounding xylem tissue.

In certain embodiments, the adaptive permeability membrane 112 includes thermally responsive materials configured to regulate permeability in response to temperature variations within the sapwood environment. Such materials may include phase-change inclusions or polymer domains exhibiting a lower critical solution temperature (LCST).

For example, microencapsulated paraffin inclusions dispersed within the polymer matrix may undergo phase transition when local sap temperature increases above a predetermined threshold (for example approximately 25° C.). During this transition, softening of the surrounding polymer matrix increases membrane permeability, thereby allowing greater transport of dissolved nutrients or analytes during periods of elevated transpiration activity.

In certain embodiments, the multi-layer membrane assembly 108 further comprises anti-embolism additives configured to suppress bubble formation during fluid exchange with the xylem system. Such additives may include non-ionic surfactants such as polysorbate-based surfactants or tree-compatible fluorosurfactants incorporated within the hydrogel matrix.

These surfactants reduce local surface tension at the membrane-tissue interface and stabilize microfluidic channels within the membrane structure. As a result, dissolved gases are less likely to nucleate bubbles when the delivered fluid enters the xylem under negative pressure conditions. This mechanism assists in maintaining embolism-free transport of fluids into the tree vascular system.

In some embodiments, the multi-layer membrane assembly 108 may be manufactured using a sequential solvent-casting or layer-by-layer deposition process. In such methods, polymer precursor solutions containing functional additives are deposited onto a substrate or support structure associated with the perforated conduit 104.

Each precursor solution may contain a distinct additive class selected from electroresponsive fillers, osmotically active polymers, enzyme-labile crosslinking agents, thermal phase-change inclusions, and anti-embolism surfactants. After deposition of each layer, the polymer matrix is cured or crosslinked to form a laminated membrane structure. Repetition of the deposition and curing process results in a stacked membrane assembly having multiple functional layers configured to regulate ionic transport, osmotic flow, and gas suppression during operation.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A tree interfacing device for systemic precision agriculture with a living tree sap wood vascular system, comprising:
a body configured to be positioned within or adjacent to xylem tissue of a tree;
at least one perforated conduit extending along a longitudinal axis of the body, wherein the at least one perforated conduit is configured to receive or deliver a fluid;
a multi-layer membrane assembly disposed between the perforated conduit and surrounding tree tissue, wherein the multi-layer membrane assembly comprises:
at least one ion-selective membrane;
at least one adaptive permeability membrane configured to be responsive to one or more tree-related parameters; and
a gas-separating membrane as an anti-gas and anti-pathogen membrane configured to inhibit entry of air or gas into the tree vascular system and to restrict entry of pathogens,
wherein the multi-layer membrane assembly is configured to modulate at least one physicochemical property of the fluid in response to the one or more tree-related parameters to regulate fluid exchange between the perforated conduit and the surrounding tree tissue; and
one or more tissue-engaging surface structures disposed on an exterior of the body, wherein the one or more tissue-engaging surface structures are configured to mechanically stabilize the tree interfacing device within tree tissue,
wherein the tree interfacing device enables controlled exchange of sap, nutrients, or analytes with the tree vascular system without inducing embolism.

2. The tree interfacing device of claim 1, wherein the at least one ion-selective membrane and the at least one adaptive permeability membrane are arranged concentrically or radially around the at least one perforated conduit.

3. The tree interfacing device of claim 1, wherein the one or more tissue-engaging surface structures are configured to engage adjacent sapwood tissue to provide mechanical stabilization during fluid exchange.

4. The tree interfacing device of claim 1, wherein the at least one ion-selective membrane comprises a cation-selective membrane, an anion-selective membrane, or a combination thereof as a fixed-charge polymer network configured to establish a stable transmembrane proton or ionic gradient across the multi-layer membrane assembly.

5. The tree interfacing device of claim 1, wherein the at least one adaptive permeability membrane is responsive to at least one of pressure, pH, temperature, ionic concentration, and electrical stimulus.

6. The tree interfacing device of claim 1, wherein the gas-separating membrane comprises a porous degassing membrane, gas-absorbing beads, a hydrophobic barrier layer, or a packed bed of hydrophilic beads embedded within a hydrogel matrix.

7. The tree interfacing device of claim 1, wherein the one or more tissue-engaging surface structures comprise micro-fins, ribs, barbs, surface texturing, or compliant protrusions configured to engage surrounding xylem tissue.

8. The tree interfacing device of claim 1, wherein the multi-layer membrane assembly is configured to generate a proton or ionic gradient of 0.1-2.0 pH units across the multi-layer membrane assembly, thereby enabling selective transport of cations, anions, or neutral solutes through layers.

9. The tree interfacing device of claim 1, wherein the at least one adaptive permeability membrane comprises electrorheological or polarizable microdomains configured to reorganize under electric, ionic, or osmotic gradients to create transient high-permeability channels analogous to symbiosome microcompartments.

10. The tree interfacing device of claim 1, wherein the tissue-engaging surface structures detect at least one of sapwood pH, ionic strength, or redox state and adjusts the multi-layer membrane assembly to regulate fluid exchange, thereby forming a closed-loop gating system.

11. The tree interfacing device of claim 1, wherein the multi-layer membrane assembly further comprises a gel-based compliant matrix disposed adjacent to the ion-selective membrane, and is configured to mechanically match xylem tissue.

12. The tree interfacing device of claim 11, wherein the gel-based compliant matrix comprises alginate, polyethylene glycol, polyvinyl alcohol, silica gel, or combinations thereof.

13. The tree interfacing device of claim 1, wherein the multi-layer membrane assembly is configured to receive an inlet of external fluid having physicochemical properties modulated relative to native sap, including at least one of a pH at least 0.3 units higher, a temperature 2-5° C. higher, and selective ionic flux configured to generate electro-osmotic flow, thereby assigning fluid properties that enable the fluid, once introduced into the sapwood, to self-drive and achieve distribution throughout the entire canopy of the tree.

14. The tree interfacing device of claim 1, wherein the tree interfacing device is configured to distribute the fluid entering through a fluid inlet to distribute across an entire tree canopy with a time period depending on fluid ion mobility rates and environmental factors.

15. The tree interfacing device of claim 1, wherein the multi-layer membrane assembly and the tissue-engaging surface structures collectively define a hydraulic permeability sufficient to regulate bidirectional fluid exchange between the tree interfacing device and xylem tissue at a rate of about 0.1-100 μL/s under native xylem tensions.

16. The tree interfacing device of claim 1, wherein the tree interfacing device is configured to be implanted, partially embedded, or externally coupled to the tree sap wood conducting system, thereby avoiding environmental exposure of chemicals in form of fertilizer or regulators for tree crop management.

17. The tree interfacing device of claim 1, wherein the tree interfacing device is configured for operation over extended time without inducing vascular blockage.

18. The tree interfacing device of claim 1, wherein the tree interfacing device is configured to suppress embolism formation with sealant and anti-gas surfactants.

19. The tree interfacing device of claim 1, wherein the tree interfacing device is configured for use in perennials, orchards and trees for agriculture purposes for holistic nutrient and health management with precision in dosage of chemicals as needed by tree and directly into tree hydraulic distribution system bypassing limitations of genetic or root-soil relations for intake of nutrients.

20. A method of interfacing with sap wood xylem tissue of a living tree for controlled exchange of fluids using a tree interfacing device, comprising:
forming an access opening in sapwood of the living tree to expose xylem tissue;
positioning the tree interfacing device within or adjacent to the xylem tissue such that an outer tissue-contacting surface of a body contacts the xylem tissue and one or more tissue-engaging surface structures mechanically stabilize the tree interfacing device within the sapwood;
establishing fluid communication between the xylem tissue and at least one perforated conduit through a perforated conduit and a multi-layer membrane assembly; and
controlling bidirectional exchange of fluid between the xylem tissue and the perforated conduit through the multi-layer membrane assembly while inhibiting entry of gas into the xylem tissue,
wherein the interfacing is maintained under native xylem pressure conditions without inducing embolism or vascular blockage.
